(19) United States
(12) Patent Application Publication
(10) Pub. No.: US 2024/0170732 A1
(43) Pub. Date: May 23, 2024

(54) MIXED POLYHALIDE ELECTROLYTES FOR A STATIC BATTERY AND A METHOD FOR FABRICATING A STATIC BATTERY CELL

(71) Applicant: Eos Energy Technology Holdings, LLC, Edison, NJ (US)

(72) Inventors: Rebecca Smith, Edison, NJ (US); Francis W. Richey, Edison, NJ (US); Lukas Fuchshofen, Edison, NJ (US)

(73) Assignee: Eos Energy Technology Holdings, LLC, Edison, NJ (US)

(21) Appl. No.: 18/500,607

(22) Filed: Nov. 2, 2023

Related U.S. Application Data
(60) Provisional application No. 63/422,229, filed on Nov. 3, 2022.

(51) Int. Cl. H01M 10/36

(52) U.S. Cl. CPC H01M 10/365; H01M 2300/0002; H01M 2300/0091

(57) ABSTRACT

Provided is a mixed polyhalide initial electrolyte for a static zinc halide battery. Also provided is a method for fabricating a static battery cell comprising the steps of: providing an initial electrolyte comprising one or more source for chloride ions and one or more source for bromide ions, wherein the one or more source for chloride ions and the one or more source for bromide ions are provided in a predetermined ratio selected to yield a target amount of mixed polyhalide upon charge of the initial electrolyte; and forming an electrochemical cell comprising an anode, a cathode and the initial electrolyte.

### CROSS-REFERENCE TO RELATED APPLICATION

This application claims the benefit of U.S. Provisional Application No. 63/422,229, filed Nov. 3, 2022, which is incorporated by reference herein in its entirety.

### TECHNICAL FIELD

Described herein are mixed polyhalide electrolytes for a static battery and a method for fabricating a static battery cell comprising the same. Specifically, described herein are mixed polyhalide electrolytes for a static zinc halide battery and a method for fabricating a static zinc halide battery cell comprising the same.

### BACKGROUND

Zinc halide batteries were developed as devices for storing electrical energy. Traditional zinc halide batteries (e.g., zinc bromide batteries) employed bipolar electrodes disposed in a static, i.e., non-flowing, zinc bromide aqueous solution. The process of charging and discharging electrical current in a zinc halide battery is generally achieved through a reaction of redox couples like Zn²⁺/Zn(s) and X⁻/X₂ in zinc halide electrolyte. When the battery is charged with electrical current, the following chemical reactions occur:

Zn²⁺+2e⁻→Zn

2X⁻→X₂+2e⁻,

wherein X is a halogen (e.g., Cl, Br, or I). Conversely, when the battery discharges electrical current, the following chemical reactions occur:

Zn→Zn²⁺+2e

X₂+2e⁻→2X⁻.

These zinc halide storage batteries were formed in a bipolar electrochemical cell stack, wherein each electrode comprises two poles, such that the anodic reaction occurs on one side of the electrode, and the cathodic reaction occurs on the opposite side of the same electrode. In this vein, bipolar electrodes were often configured as plates, and the cell stack was assembled to form a prismatic geometry. During charging and discharging of the bipolar battery, the electrode plates function as conductors for adjacent cells, i.e., each electrode plate serves as the anode for one cell and the cathode for the adjacent cell. In this prismatic battery geometry, the entire surface area of the electrode plate that separates adjacent electrochemical cells transfers current from cell to cell.

Accordingly, when a traditional bipolar zinc halide battery charges, zinc metal electrolytically plates on the anode side of the bipolar electrode plate, while molecular halogen species form at the cathode side of the electrode plate. And, when the battery discharges, the plated zinc metal is oxidized to free electrons that are conducted through the electrode plate and reduce the molecular halogen species to generate halide anions.

Historically, static zinc bromide batteries achieve limited energy and power density due to density gradients observed in the electrolyte. During battery charging, as dense polybromide phases form and subsequently sink to bottom of the cell, it becomes difficult to utilize the entire electrode surface area when charging to higher capacity, and in turn higher energy density. Hence, the static zinc halide batteries face the inherent challenges of simultaneously increasing energy and power density of the static zinc halide battery, without the use of flowing electrolyte. Since flow batteries use flowing electrolytes, such density gradients are not observed in the electrolyte of such flow batteries. Hence, the abovementioned challenges of static zinc halide batteries are not relevant to flow zinc halide batteries.

Chinese Patent No. CN102479968B discloses a redox flow battery which uses a zinc chloride and zinc bromide solution as the electrolyte. The anode and the cathode are made of an inert electrically conductive material, and the zinc chloride and zinc bromide solutions are stored in the anode electrolyte storage tank and the cathode electrolyte storage tank, respectively. During the operation of the battery, the electrolyte solution circulates between the battery module and the electrolyte storage tanks with the aid of the circulation pumps.

The use of BrCl₂⁻/Br⁻ as a positive redox couple was demonstrated in a Ti—Br—Cl flow battery (TBCFB). See, e.g., Xu, Y. et al., “A High Energy Density Bromine-Based Flow Battery with Two-Electron Transfer,” ACS Energy Lett., 7, 1034-1039 (2022). See also Zou, Y. et al., “A Four-electron Zn—I₂ Aqueous Battery Enabled by Reversible I⁻/I₂/I⁺ Conversion,” Nature Commc'ns, 12, 170 (2021).

Biswas, S. et al., “Minimal Architecture Zinc-bromine Battery for Low-Cost Electrochemical Energy Storage,” Energy Env't Sci., 10, 114-120 (2017), discuss the issue arising from the tendency of polybromide species to separate and stratify in aqueous systems. However, they address the challenge by proposing a horizontal cell architecture that places the bromine cathode on the bottom of the cell and the zinc anode at the top and forgo the use of complexing agents. This approach purportedly keeps the polybromide species where they need to be, but introduces new challenges for a commercially scalable cell architecture related to gassing, zinc plating, and efficient packing of cells.

### BRIEF SUMMARY

The present disclosure describes mixed polyhalide initial electrolytes for a static zinc halide battery. The present disclosure also describes a method for fabricating a static zinc halide battery cell comprising the same.

In one aspect, the present disclosure describes a method for fabricating a static battery cell comprising the steps of: providing an initial electrolyte comprising one or more source(s) for chloride ions and one or more source(s) for bromide ions, wherein the one or more source(s) for chloride ions and the one or more source(s) for bromide ions are provided in a predetermined ratio selected to yield a target amount of mixed polyhalide upon charge of the initial electrolyte; and forming an electrochemical cell comprising an anode, a cathode and the initial electrolyte.

In some embodiments, the static battery cell is a static zinc halide electrochemical cell.

In some embodiments, the static zinc halide electrochemical cell is in a static zinc halide battery.

The initial electrolyte comprises one or more source(s) for chloride ions. Non-limiting examples of the one or more source for chloride ions include, for example, ZnCl₂, KCl, NH₄Cl, LiCl, CuCl₂, CaCl₂, FeCl₃, SbCl₃, CrCl₃, NaCl, BiCl₃, quaternary ammonium salts with chloride anions, or combination thereof.

The initial electrolyte comprises one or more source(s) for bromide ions. Non-limiting examples of the one or more source for bromide ions include, for example, ZnBr₂, KBr, NH₄Br, LiBr, CuBr₂, CaBr₂, NaBr, AgBr, AlBr₃, quaternary ammonium salts with bromide anions, or combination thereof.

In some embodiments, the predetermined ratio of the one or more source for chloride ions and the one or more source for bromide ions is a molar ratio of total chloride ions to total bromide ions from about 1:1 to about 13:1.

In some embodiments, the predetermined ratio of the one or more source for chloride ions and the one or more source for bromide ions is a molar ratio of total chloride ions to total bromide ions from about 1:1 to about 2:1.

In some embodiments, the predetermined ratio of the one or more source for chloride ions and the one or more source for bromide ions is a molar ratio of total chloride ions to total bromide ions from about 1.25:1 to about 1.5:1.

Another aspect of the present disclosure describes an initial electrolyte for use in a static secondary zinc halide electrochemical cell comprising: from about 5 wt. % to about 30 wt. % of ZnBr₂; from about 5 wt. % to about 60 wt. % of ZnCl₂; from about 10 wt. % to about 60 wt. % of H₂O; and from about 0.05 wt. % to about 20 wt. % of one or more quaternary ammonium agent. In a further aspect, upon at least significant charge of the initial electrolyte, a mixed polyhalide is formed.

In some embodiments, the mixed polyhalides that may be produced upon charge, significant charge, or a charge that exceeds significant charge have a general formula [X₍₂ₙ₊₁₎Y₍₂ₘ₎]⁻, where X and Y are different from each other and are independently either Cl or Br, n is an integer between 0 and 5, and m is an integer between 1 and 5.

In some embodiments, a mixed polyhalide is formed when the initial electrolyte (with different halides at the predetermined ratio) within an electrochemical cell has undergone charging until it has reached an open circuit potential of greater than 1.82V and a volumetric charge capacity of greater than 54 mAh/mL.

In some embodiments, the one or more quaternary ammonium agent is independently selected from a quaternary ammonium agent having a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide.

In some embodiments, the initial electrolyte further comprises from about 0.5 wt. % to about 15 wt. % of KBr and from about 0.5 wt. % to about 15 wt. % of KCl.

In some embodiments, the initial electrolyte further comprises from about 0.5 wt. % to about 15 wt. % of KCl.

### BRIEF DESCRIPTION OF DRAWINGS

These and other features, aspects, and advantages of the present disclosure will become better understood when the following detailed description is read with reference to the accompanying drawings.

FIG. 1 shows an exploded view of an electrochemical cell according to an embodiment of the present disclosure.

FIG. 2 is a side view of a battery according to an embodiment in the present disclosure.

FIG. 3 is an exploded view of the battery of FIG. 2.

FIG. 4 is an exploded view of a terminal assembly for use in the battery of FIG. 2.

FIG. 5 is a front view of a battery frame member for use in the battery of FIG. 2.

FIG. 6 shows the effect of decreasing the molar ratio of zinc chloride to zinc bromide in an electrolyte on the formation of a polybromide at the bottom of the vial.

FIG. 7 shows representative voltage as a function of test time for a mixed polyhalide initial electrolyte according to embodiments in the present disclosure and a zinc bromide initial electrolyte (control) which forms polybromide on charge and does not form the mixed polyhalide as in the present disclosure.

FIG. 8 shows the effect of total Cl/Br molar ratio in a mixed polyhalide initial electrolyte according to embodiments in the present disclosure on discharge energy (Wh).

FIG. 9 shows representative average coulombic efficiency (%) over ten charge and discharge cycles for a mixed polyhalide initial electrolyte according to embodiments in the present disclosure and a zinc bromide initial electrolyte which forms polybromide on charge and does not form the mixed polyhalide as in the present disclosure.

FIG. 10 shows representative average coulombic efficiency as a function of cycle length for a mixed polyhalide initial electrolyte according to embodiments in the present disclosure and a zinc bromide initial electrolyte which forms polybromide on charge and does not form the mixed polyhalide as in the present disclosure.

FIG. 11 shows representative cell discharge voltage (V) as a function of cell discharge energy density (Wh/L) for a mixed polyhalide initial electrolyte according to embodiments in the present disclosure and a zinc bromide initial electrolyte which forms polybromide on charge and does not form the mixed polyhalide as in the present disclosure.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

### I. DEFINITIONS

As used herein, the term “electrochemical cell” or “cell” are used interchangeably to refer to a device capable of either generating electrical energy from chemical reactions or facilitating chemical reactions through the introduction of electrical energy. An electrochemical cell may be a part of a bipolar stack or be a unipolar (or monopolar) electrochemical cell. An electrochemical cell may be connected to any number of other electrochemical cells, either in series or in parallel connection, or be a standalone device.

As used herein, the term “battery” encompasses electrical storage devices comprising at least one electrochemical cell. For example, a battery may be comprised of about 5 to 50 electrochemical cells in series. A “secondary battery” is rechargeable, whereas a “primary battery” is not rechargeable. For secondary batteries of the present disclosure, a battery anode is designated as the positive electrode during discharge, and as the negative electrode during charge. Conversely, the battery cathode is designated as the negative electrode during discharge and the positive electrode during charge.

As used herein, the term “electrode” refers to an electrical conductor used to make contact with a nonmetallic part of a circuit (e.g., a semiconductor, an electrolyte, or a vacuum). An electrode may also refer to either an anode or a cathode.

As used herein, the term “anode” refers to the negative electrode from which electrons flow during the discharging phase in the battery. The anode is also the electrode that undergoes chemical oxidation during the discharging phase. However, in secondary, or rechargeable, cells, the anode is the electrode that undergoes chemical reduction during the cell's charging phase. Anodes are formed from electrically conductive or semiconductive materials, e.g., metals (e.g., titanium or TiC coated titanium), metal oxides, metal alloys, metal composites, semiconductors, conductive plastics, or the like.

As used herein, the term “cathode” refers to the positive electrode into which electrons flow during the discharging phase in the battery. The cathode is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., metals, metal oxides, metal alloys, metal composites, semiconductors, conductive plastics, or the like.

As used herein, the term “monopolar electrode” or “unipolar electrode” refers to an electrode that functions as the anode of a cell or the cathode of the cell without contributing to electrochemical reactions of an additional cell.

As used herein, the term “bipolar electrode” refers to an electrode that functions as the anode of one cell and the cathode of another cell. For example, in a battery, a bipolar electrode functions as an anode in one cell and functions as a cathode in an immediately adjacent cell. In some examples, a bipolar electrode comprises two surfaces, a cathode surface and an anode surface, wherein the two surfaces are connected by a conductive material. For instance, a bipolar electrode plate may have opposing surfaces wherein one surface is the anode surface, the other surface is the cathode surface, and the conductive material is the thickness of the plate between the opposing surfaces.

As used herein, an “electrolyte” refers to a substance that behaves as an electrically conductive medium. For example, the electrolyte facilitates the mobilization of electrons and cations in the cell. Electrolytes include mixtures of materials such as aqueous solutions of metal halide salts (e.g., ZnBr₂, ZnCl₂, or the like).

As used herein, the term “halogen” refers to any of the elements fluorine, chlorine, bromine, iodine, and astatine, occupying group VILA (17) of the periodic table. Halogens are reactive nonmetallic elements that form strongly acidic compounds with hydrogen, from which simple salts can be made.

As used herein, the term “halide” refers to a binary compound of a halogen with another element or radical that is less electronegative (or more electropositive) than the halogen, to make a fluoride, chloride, bromide, iodide, or astatide compound.

As used herein, the term “polyhalide” refers to a molecular ion containing three or more halogen atoms of the same type and having an overall charge of −1. Non-limiting examples of polyhalide include, for example, Br₃⁻, Br₅⁻, Cl₃⁻, or Cl₅⁻.

As used herein, the term “polybromide” refers to a molecular ion containing three or more bromine atoms and having an overall charge of −1. During battery charge in a halide electrolyte composed predominantly of bromide ions dissolved in solution, bromides will be electrochemically converted to bromine (Br₂), which subsequently binds to free bromide in solution to form polybromides. Polybromides typically form a non-aqueous phase in the electrolyte upon formation. Non-limiting examples of polybromide include, for example, Br₃⁻ and Br₅⁻ (MW of 239.7 and 399.5 g/mol, respectively).

As used herein, “mixed polyhalide” refers to a molecular ion containing three or more halogen atoms of different types, such as bromine and chlorine atoms, and having an overall charge of −1. During battery charge in an uncharged electrolyte composed of a selected ratio of bromide and chloride ions dissolved in solution, bromides will be electrochemically converted to bromine (Br₂), and then at higher charge voltage, the bromine will be further oxidized in combination with chloride ions in solution to form a mixed polyhalide. In one aspect, mixed polyhalides are formed when using an uncharged electrolyte with a predetermined ratio of different halide ions. Non-limiting examples of a predetermined ratio of different halide ions in an uncharged electrolyte include, for example, a total chloride to bromide molar ratio of 1:1 to 13:1. Preferably, the total chloride to bromide molar ratio in an uncharged electrolyte is in the range of from about 1.5:1 to about 2.5:1. Non-limiting examples of mixed polyhalide include, for example, BrCl₂ (MW of 150.8 g/mol) or ClBr₂ (MW of 195.3 g/mol).

As used herein, the term “anion” refers to any chemical entity having one or more permanent negative charges. Examples of anions include, but are not limited to fluoride, chloride, bromide, iodide, arsenate, phosphate, arsenite, hydrogen phosphate, dihydrogen phosphate, sulfate, nitrate, hydrogen sulfate, nitrite, thiosulfate, sulfite, perchlorate, iodate, chlorate, bromate, chlorite, hypochlorite, hypobromite, carbonate, chromate, hydrogen carbonate (bicarbonate), dichromate, acetate, formate, cyanide, amide, cyanate, peroxide, thiocyanate, oxalate, hydroxide, and permanganate.

As used herein, a “titanium material” may include, but is not limited to, titanium (in any oxidation state), TiC, alloys of TiC such as TiCxM (where x is 0, 1, 2, 3, or 4 and M is a metal), titanium carbohydrides, non-stoichiometric titanium-carbon compounds, and combinations thereof.

As used herein, “titanium carbide” is used interchangeably with “titanium carbide material” and includes, but is not limited to TiC, alloys of TiC such as TiCxM (where x is 0, 1, 2, 3, or 4 and M is a metal), titanium carbohydrides, non-stoichiometric titanium-carbon compounds, and combinations thereof.

As used herein, the term “zinc metal” refers to elemental zinc, also commonly known as Zn(0) or Zn°.

For purposes of this disclosure, the term “dimethyl ether poly(ethylene glycol)”, “DME-PEG”, is used interchangeably to refer to a polymer having the structure

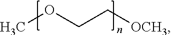

where n is an integer. DME-PEG 1000 refers to a DME-PEG polymer having a number average molecular weight (M n) about 1000 amu, and DME-PEG 2000 refers to a DME-PEG polymer having a number average molecular weight (M n) of about 2000 amu.

As used herein, the term “dimethyl ether” refers to an organic compound having the formula CH₃OCH₃.

As used herein, the term “aggregate concentration” refers to the sum total concentration (e.g., wt. %) of each constituent of a class of ingredients or a class of agents (e.g., quaternary ammonium agents). In one example, the aggregate concentration of one or more quaternary ammonium agents in an electrolyte is the sum total of the concentrations (e.g., weight percents) of each constituent quaternary ammonium agent present in the electrolyte. Thus, if the electrolyte has three quaternary ammonium agents, the aggregate concentration of the three quaternary ammonium agents is the sum of the concentrations for each of the three quaternary ammonium agents present in the electrolyte. And, if the electrolyte has only one quaternary ammonium agent, the aggregate concentration of the quaternary ammonium agents is simply the concentration of the single quaternary ammonium agent present in the electrolyte.

As used herein, the term “alcohol” refers to any organic compound whose molecule contains one or more hydroxyl groups attached to a carbon atom. Examples of alcohols include methanol, ethanol, 1-propanol (i.e., n-propanol), 2-propanol (i.e., iso-propanol), 1-butanol (i.e., n-butanol), sec-butanol, iso-butanol, tert-butanol, 1-pentanol, or any combination thereof.

As used herein, the term “hydroxyl group” refers to an —OH group.

As used herein, the term “glycol” refers to any of a class of organic compounds belonging to the alcohol family. In the molecule of a glycol, two hydroxyl (— OH) groups are attached to different carbon atoms. Examples of glycols include C₁₋₁₀ glycols including ethylene glycol, propylene glycol, 1,3-butylene glycol, 1,4-butylene glycol, neopentyl glycol, hexalene glycol, or any combination thereof. Other examples of glycols include substituted ethylene and substituted propylene glycols.

As used herein, the term “weight percent” and its abbreviation wt. %” or “wt %” are used interchangeably to refer to the product of 100 times the quotient of mass of one or more components divided by total mass of a mixture or product containing said component:

wt %=100%×(mass of component(s)/total mass)

When referring to the concentration of components or ingredients for electrolytes, as described herein, wt. % or wt % is based on the total weight of the electrolyte.

As used herein, the term “quaternary ammonium agent” refers to any compound, salt, or material comprising a quaternary nitrogen atom. Non-limiting examples of quaternary ammonium agents include, for example, tetra-alkylammonium halides (e.g., tetramethylammonium bromide, tetramethylammonium chloride, tetraethylammonium bromide, tetraethylammonium chloride, alkyl-substituted pyridinium halides, alkyl-substituted morpholinium halides, combinations thereof or the like), heterocyclic ammonium halides (e.g., alkyl-substituted pyrrolidinium halide (e.g., N-methyl-N-ethylpyrrolidinium halide or N-ethyl-N-methylpyrrolidinium halide), alkyl-substituted pyridinium halides, alkyl-substituted morpholinium halides, viologens having at least one quaternary nitrogen atom, combinations thereof, or the like), or any combination thereof. Tetra-alkylammonium halides may be symmetrically substituted or asymmetrically substituted with respect to the substituents of the quaternary nitrogen atom.

As used herein, the term “viologen” refers to any bipyridinium derivative of 4-4′-bipyridine.

As used herein and in zinc halide battery literature, “complexing agent” typically refers to quaternary ammonium organic compound that has a positive charge. The complexing agent is used to fuse, bind, or complex the polybromide or polyhalide species that are formed in the battery, thus, creating a species where the positively charged quaternary ammonium and the negatively charge polybromide or polyhalide are one compound with decreased vapor pressure and higher thermodynamic stability.

As used herein, the term “ammonium bromide complexing agent” refers to any compound, salt, or material comprising a quaternary nitrogen atom, wherein the quaternary nitrogen atom is not part of an imidazolium, pyridinium, pyrrolidinium, morpholinium, or phosphonium moiety. Examples of ammonium bromide complexing agents include: tetraethylammonium bromide, trimethylpropylammonium bromide, dodecyltrimethylammonium bromide, cetyltriethylammonium bromide, and hexyltrimethylammonium bromide.

As used herein, the term “imidazolium bromide complexing agent” refers to any compound, salt, or material comprising a quaternary nitrogen atom, wherein the quaternary nitrogen atom is part of an imidazolium moiety. Examples of imidazolium bromide complexing agents include: 1-ethyl-3-methylimidazolium bromide, 1-butyl-3-methylimidazoliium bromide, 1-ethyl-2,3-dimethylimidazolium bromide, 1-decyl-3-methylimidazolium bromide, 1-butyl-2,3-dimethylimidazolium bromide, 1-methyl-3-octylimidazollium bromide, and 1-methyl-3-hexylimidazolium bromide.

As used herein, the term “pyridinium bromide complexing agent” refers to any compound, salt, or material comprising a quaternary nitrogen atom, wherein the quaternary nitrogen atom is part of a pyridinium moiety. Examples of pyridinium bromide complexing agents include: 1-ethyl-2-methylpyridinium bromide, 1-ethyl-3-methylpyridinium bromide, 1-ethyl-4-methylpyridinium bromide, 1-butyl-3-methylpyridinium bromide, 1-butyl-3-methylpyridinium bromide, 1-butyl-4-methylpyridinium bromide, and 1-hexylpyridinium bromide.

As used herein, the term “pyrrolidinium bromide complexing agent” refers to any compound, salt, or material comprising a quaternary nitrogen atom, wherein the quaternary nitrogen atom is part of a pyrrolidinium moiety. An example of a pyrrolidinium bromide complexing agent is 1-butyl-1-methylpyrrolidinium bromide.

As used herein, the term “morpholinium bromide complexing agent” refers to any compound, salt, or material comprising a quaternary nitrogen atom, wherein the quaternary nitrogen atom is part of a morpholinium moiety. An example of a morpholinium bromide complexing agent is N-ethyl-N-methylmorpholinium bromide.

As used herein, the term “phosphonium bromide complexing agent” refers to any compound, salt, or material comprising a quaternary phosphonium atom. An example of a phosphonium bromide complexing agent is tetraethylphosphonium bromide.

As used herein, the term “crown ether” refers to a cyclic chemical compound consisting of a ring containing at least three ether groups. Examples of crown ethers include 12-crown-4, 15-crown-5, 18-crown-6, dibenzo-18-crown-6, and diaza-18-crown-6.

As used herein, an “alkyl” group refers to a saturated aliphatic hydrocarbon group containing 1-20 (e.g., 1-16, 1-12, 1-8, 1-6, or 1-4) carbon atoms. An alkyl group can be straight or branched. Examples of alkyl groups include, but are not limited to, methyl, ethyl, propyl, isopropyl, butyl, isobutyl, sec-butyl, tert-butyl, pentyl, hexyl, heptyl, 2-ethylhexyl, octyl, nonyl, decyl, dodecyl, and cetyl.

As used herein, an “aryl” group used alone or as part of a larger moiety as in “aralkyl”, “aralkoxy”, or “aryloxyalkyl” refers to monocyclic (e.g., phenyl); bicyclic (e.g., indenyl, naphthalenyl, tetrahydronaphthyl, tetrahydroindenyl); tricyclic (e.g., fluorenyl, tetrahydrofluorenyl, anthracenyl, or tetrahydroanthracenyl); or a benzofused group having 3 rings. For example, a benzofused group includes phenyl fused with two or more C₄₋₈ carbocyclic moieties. An aryl is optionally substituted with one or more substituents including aliphatic (e.g., alkyl, alkenyl, or alkynyl); cycloalkyl; (cycloalkyl)alkyl; heterocycloalkyl; (heterocycloalkyl)alkyl; aryl; hetero aryl; alkoxy; cycloalkyloxy; heterocycloalkyloxy; aryloxy; heteroaryloxy; aralkyloxy; heteroaralkyloxy; aroyl; heteroaroyl; amino; amino alkyl; nitro; carboxy; carbonyl (e.g., alkoxycarbonyl, alkylcarbonyl, aminocarbonyl, (alkylamino)alkylaminocarbonyl, arylaminocarbonyl, heteroarylaminocarbonyl; or sulfonylcarbonyl); aryalkylcarbonyloxy; sulfonyl (e.g., alkylsulfonyl or aminosulfonyl); sulfinyl (e.g., alkylsulfinyl); sulfanyl (e.g., alkylsulfanyl); cyano; halo; hydroxyl; acyl; mercapto; sulfoxy; urea; thiourea; sulfamoyl; sulfamide; oxo; or carbamoyl. Alternatively, an aryl may be unsubstituted.

Examples of substituted aryls include haloaryl, alkoxycarbonylaryl, alkylaminoalkylaminocarbonylaryl, p, m-dihaloaryl, p-amino-p-alkoxycarbonylaryl, m-amino-m-cyanoaryl, aminoaryl, alkylcarbonylaminoaryl, cyanoalkylaryl, alkoxyaryl, aminosulfonylaryl, alkylsulfonylaryl, aminoaryl, p-halo-m-aminoaryl, cyanoaryl, hydroxyalkylaryl, alkoxyalkylaryl, hydroxyaryl, carboxyalkylaryl, dialkylaminoalkylaryl, m-heterocycloaliphatic-o-alkylaryl, heteroarylaminocarbonylaryl, nitroalkylaryl, alkylsulfonylaminoalkylaryl, heterocycloaliphaticcarbonylaryl, alkylsulfonylalkylaryl, cyanoalkylaryl, heterocycloaliphaticcarbonylaryl, alkylcarbonylaminoaryl, hydroxyalkylaryl, alkylcarbonylaryl, aminocarbonylaryl, alkylsulfonylaminoaryl, dialkylaminoaryl, alkylaryl, and trihaloalkylaryl.

As used herein, an “aralkyl” group refers to an alkyl group (e.g., a C₁₋₄ alkyl group) that is substituted with an aryl group. Both “alkyl” and “aryl” are defined herein. An example of an aralkyl group is benzyl. A “heteroaralkyl” group refers to an alkyl group that is substituted with a heteroaryl.

As used herein, a “cycloalkyl” group refers to a saturated carbocyclic mono-, bi-, or tri-, or multicyclic (fused or bridged) ring of 3-10 (e.g., 5-10) carbon atoms. Without limitation, examples of monocyclic cycloalkyl groups include cyclopropyl, cyclobutyl, cyclopentyl, cyclohexyl, cycloheptyl, or the like. Without limitation, examples of bicyclic cycloalkyl groups include octahydro-indenyl, decahydro-naphthyl, bicyclo[3.2.1]octyl, bicyclo[2.2.2]octyl, bicyclo[3.3.1]nonyl, bicyclo[3.3.2.]decyl, bicyclo[2.2.2]octyl, bicycle[2.2.1]heptanyl, bicycle[3.1.1]heptanyl, or the like. Without limitation, multicyclic groups include adamantyl, cubyl, norbornyl, or the like. Cycloalkyl rings can be optionally substituted at any chemically viable ring position.

As used herein, a “heterocycloalkyl” group refers to a 3-10 membered mono or bicyclic (fused or bridged) (e.g., 5 to 10 membered mono or bicyclic) saturated ring structure, in which one or more of the ring atoms is a heteroatom (e.g., N, O, S, or combinations thereof). Examples of a heterocycloalkyl group include optionally substituted piperidyl, piperazyl, tetrahydropyranyl, tetrahydrofuryl, 1,4-dioxolanyl, 1,4-dithianyl, 1,3-dioxolanyl, oxazolidyl, isoxazolidyl, morpholinyl, thiomorpholyl, octahydro-benzofuryl, octahydro-chromenyl, octahydro-thiochromenyl, octahydro-indolyl, octahydro-pyrindinyl, decahydro-quinolinyl, octahydro-benzo[b]thiopheneyl, 2-oxa-bicyclo[2.2.2]octyl, 1-aza-bicyclo[2.2.2]octyl, 3-aza-bicyclo[3.2.1]octanyl, 2,6-dioxa-tricyclo[3.3.1.0^{3,7}]nonyl, tropane. A monocyclic heterocycloalkyl group may be fused with a phenyl moiety such as tetrahydroisoquinoline. Heterocycloalkyl ring structures can be optionally substituted at any chemically viable position on the ring or rings.

A “heteroaryl” group, as used herein, refers to a monocyclic, bicyclic, or tricyclic ring structure having 4 to 15 ring atoms wherein one or more of the ring atoms is a heteroatom (e.g., N, O, S, or combinations thereof) and wherein one or more rings of the bicyclic or tricyclic ring structure is aromatic. A heteroaryl group includes a benzo fused ring system having 2 to 3 rings. For example, a benzo fused group includes benzo fused with one or two C₄₋₈ heterocyclic moieties (e.g., indolizyl, indolyl, isoindolyl, 3H-indolyl, indolinyl, benzo[b]furyl, benzo[b]thiophenyl, quinolinyl, or isoquinolinyl). Some examples of heteroaryl are azetidinyl, pyridyl, 1H-indazolyl, furyl, pyrrolyl, thienyl, thiazolyl, oxazolyl, imidazolyl, tetrazolyl, benzofuryl, isoquinolinyl, benzthiazolyl, xanthene, thioxanthene, phenothiazine, dihydroindole, benzo[1,3]dioxole, benzo[b]furyl, benzo[b]thiophenyl, indazolyl, benzimidazolyl, benzthiazolyl, puryl, cinnolyl, quinolyl, quinazolyl, cinnolyl, phthalazyl, quinazolyl, quinoxalyl, isoquinolyl, 4H-quinolizyl, benzo-1,2,5-thiadiazolyl, or 1,8-naphthyridyl. Heteroaryls also include bipyridine compounds.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” comprises any and all combinations of one or more of the associated listed items.

The terms, upper, lower, above, beneath, right, left, etc. may be used herein to describe the position of various elements with relation to other elements. These terms represent the position of elements in an example configuration. However, it will be apparent to one skilled in the art that the battery frame member may be rotated in space without departing from the present disclosure and thus, these terms should not be used to limit the scope of the present disclosure.

As used herein, “plurality” refers to two or more of the elements being described. In some embodiments, plurality refers to three or more, four or more, or five or more of the elements being described.

As used herein, “chemically compatible” refers to a material that does not interfere with the chemistry of an electrochemical cell in a way that meaningfully negatively impacts the performance of the electrochemical cell. The chemically compatible material is chemically compatible with electrolyte (e.g., zinc halide electrolyte, alkaline electrolyte) and anode and cathode materials.

As used herein, “chemically inert” refers to a material that does not chemically react in any meaningful way with the electrolyte, anode, or cathode of an electrochemical cell.

As used herein, “upon charge”, “during charge”, or “charging” refers to a charging process of an electrochemical cell that occurs when an external current is applied across the electrochemical cell with the cathode being the positive terminal and the anode being the negative terminal. Either an electrochemical cell, the electrolyte within an electrochemical cell, or a battery may be said to be “charging.”

As used herein, “initial electrolyte” or “uncharged electrolyte” refer to the electrolyte before charge.

As used herein, “charged electrolyte” or “electrolyte having been charged” refers to an electrolyte contained within an electrochemical cell, that has undergone any amount of charging so that it is no longer in the “initial electrolyte” state.

As used herein, “charged electrochemical cell” or “electrochemical cell having been charged” refers to an electrochemical cell that has undergone any amount of charging so that an electrolyte contained within the electrochemical cell is no longer in the “initial electrolyte” state.

As used herein, “significant charge” or “having received significant charge” in the context of an electrochemical cell or an electrolyte contained within an electrochemical cell refers to an electrochemical cell, or an electrolyte contained within an electrochemical cell, that has undergone charging until it has reached an open circuit potential of at least 1.82V and a volumetric charge capacity of at least 54 mAh/mL.

As used herein, the term “mixed polyhalide electrolyte” refers to an aqueous electrolyte with a mixture of bromide and chloride ions in solution, which upon receipt of, in one aspect, a significant charge forms a mixed polyhalide. As used herein, “mixed polyhalide electrolyte” is an umbrella term that covers both the initial electrolyte and the charged electrolyte at any state of charge. However, for clarity, the mixed polyhalide is only present in significant amounts in the charged electrolyte when it has received a significant charge.

As used herein, “electrolyte density gradient” refers to regions in the electrolyte that have different densities due to the varying distribution of molecular species having different molecular weights within the charged electrolyte. In one aspect, the electrolyte density gradient is a result of molecular ions containing three or more halogen atoms (of the same type or different types) and of different molecular weights within the charged electrolyte.

As used herein, “coulombic efficiency” of a secondary battery refers to the ratio of discharge capacity to charge capacity within the same charge/discharge cycle.

As used herein, “current density distribution” of a battery refers to the variance in local current density across the surface of an electrode.

### II. ELECTROCHEMICAL CELL AND BATTERY

In one aspect, the present disclosure provides an initial electrolyte for use in a static secondary zinc halide electrochemical cell and battery. In another aspect, the present disclosure provides a static secondary zinc halide battery comprising the initial electrolyte.

A. Electrolyte

The present disclosure provides an initial electrolyte that is useful in non-flowing (i.e., static) secondary zinc halide electrochemical cells and batteries. In these electrochemical cells and batteries, zinc halides (e.g., combination of zinc bromide and zinc chloride) present in the initial electrolyte act as the electrochemically active material. These electrochemical cells and batteries are described below.

The initial electrolyte of the present disclosure is a zinc halide electrolyte that is in contact with at least one electrode of the electrochemical cell. The initial electrolyte is mechanically isolated in each cell of the static secondary zinc halide battery. In some embodiments, the electrode is a bipolar electrode and the initial electrolyte is interposed between an inner surface of a terminal endplate, a cathode assembly, a front surface of the bipolar electrode, and if present, interior surfaces of a frame.

In an embodiment of a static secondary zinc bromide battery, for example, positively charged zinc ions and negatively charged halide ions need to be available at the anode and cathode electrode, respectively.

In a traditional zinc bromide initial electrolyte with low concentration of chloride, the bromide anions at or near the cathode electrode (e.g., carbon material of the cathode assembly) that is exposed to the electrolyte are oxidized to bromine when the electrochemical cell or battery is charging. Conversely, during discharge, the bromine is reduced to bromide anions.

The bromine combines with the bromide to form polybromide anions at or near the cathode electrode can be expressed as follows:

2Br⁻↔Br₂+2e⁻;Br₂+Br⁻↔Br₃⁻;E=1.04V (1).

In a traditional zinc bromide initial electrolyte with low concentration of chloride, as seen above in Equation (1), polybromide (for example, Br₃⁻ and Br₅⁻ (MW of 239.7 and 399.5 g/mol, respectively)) form during charging, which have a density that is much higher than the aqueous electrolyte density of ˜1.6 g/mL, causing nonuniform electrolyte height gradients and in turn poor utilization of electrode surface area in an electrochemical cell that has received a significant charge. For example, when the polybromide is Br₃⁻, the density of the electrolyte is between about 2.0 g/ml to about 2.2 g/ml. Hence, historically, one of the biggest challenges to static zinc halide batteries is electrolyte density gradients across the height of the electrochemical cell resulting in non-uniform electrode utilization and limited energy and power density.

One pathway to reducing the electrolyte density gradients across the height of the cell is to create an initial electrolyte with a mixed chloride/bromide polyhalide with a lower density than the previously known polybromide. In mixed halide initial electrolytes with high concentration of zinc chloride, mixed polyhalide (for example, BrCl₂ (MW of 150.7 g/mol)) can form with significantly lower density than the traditional polybromide (for example, Br₃⁻ and Br₅⁻ (MW of 239.7 and 399.5 g/mol, respectively)). Hence, the mixed polyhalide that are formed have a significantly lower density than the traditional polybromide, and thus, reduce the electrolyte density gradients across the height of the cell.

As the zinc chloride to zinc bromide molar ratio increases, the cathode reaction can change from Equation (1) above to Equation (2) below:

2Br⁻+4Cl⁻↔2BrCl₂⁻+2e⁻;E=1.3V (2).

As Equation (2) becomes the dominant cathode reaction in a static zinc halide battery (instead of Equation (1)), an added benefit which solves numerous historical problems of static zinc halide batteries is that the final product of Equation (2) is of a significantly lower molecular weight than the final product of Equation (1). This results in an initial electrolyte with a mixed polyhalide, which is lower density for Equation (2), and does not sink to the bottom of the cell, allowing for full electrode height utilization. Further, Equation (2) is at higher voltage than Equation (1), which makes for a higher energy battery.

The present disclosure is for an initial electrolyte which can specifically be used in a static zinc halide battery, where the initial electrolyte is a mixed chloride/bromide electrolyte that is capable of achieving higher voltage, higher energy and power density, and lower density mixed polyhalide. This is achieved by formulating the mixed chloride/bromide electrolyte to have the right concentration and ratio of zinc chloride, zinc bromide, potassium chloride, and potassium bromide, along with appropriate complexing agents and zinc plating additives. The lower density of the mixed polyhalide of these initial electrolytes is critical to solving the problem of electrolyte density gradients (stratification) across the electrolyte height in traditional static zinc bromide batteries, where the polybromide formed from charging the electrolyte are much denser than the initial aqueous electrolyte, resulting in polybromides accumulating on the bottom of cell and nonuniform electrode height utilization during discharge.

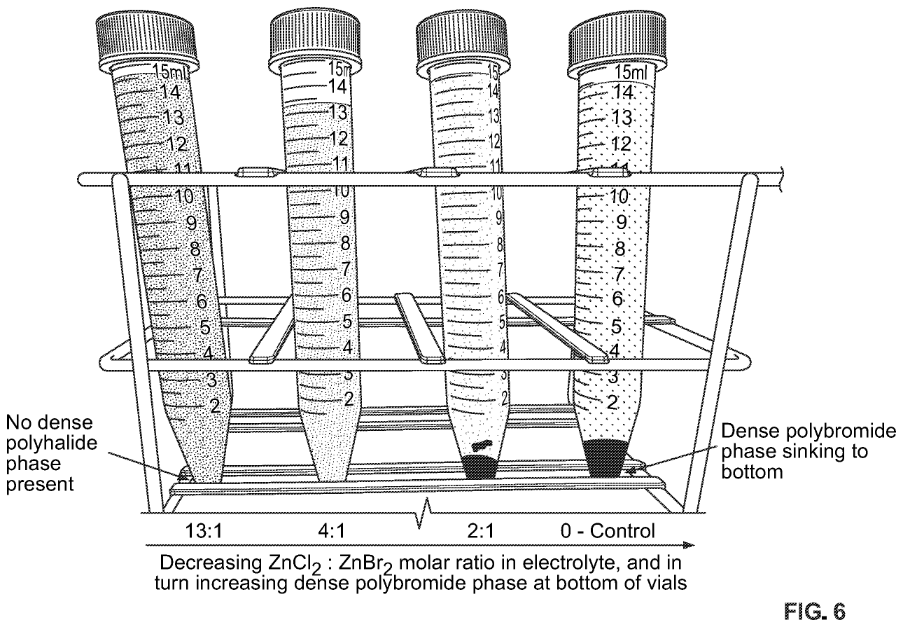

FIG. 6 shows the effect of decreasing the molar ratio of zinc chloride to zinc bromide in an electrolyte on the formation of a polybromide at the bottom of the vial. The shading shown is representative of the coloring and opacity in the aqueous phase of a given sample, arising from the distribution of halide complexes suspended or dissolved in that sample. As seen in FIG. 6, decreasing the molar ratio of zinc chloride to zinc bromide in the initial electrolyte results in the formation of the aforementioned dense polybromide at the bottom of the vial. As a result, the initial electrolytes with higher zinc chloride form mixed polyhalides which are buoyant in the electrolyte, and do not sink or accumulate in the bottom of the vial. The implication of this result is that the full height of the static zinc halide battery can be fully utilized when initial electrolytes with an equal or a greater proportion of chloride than bromide are used, a significant improvement on historical static zinc bromide batteries. In some embodiments, the total chloride to bromide molar ratio in the uncharged or initial electrolyte is between about 1:1 and about 13:1. Preferably, the total chloride to bromide molar ratio in the uncharged or initial electrolyte is from about 1:1 to about 2:1. Preferably, the total chloride to bromide molar ratio in the uncharged or initial electrolyte is from about 1.25:1 to about 1.5:1.

One aspect of the present disclosure provides an uncharged or initial electrolyte for use in a static secondary zinc halide electrochemical cell comprising: from about 5 wt. % to about 30 wt. % of ZnBr₂; from about 5 wt. % to about 60 wt. % of ZnCl₂; from about 10 wt. % to about 60 wt. % of H₂O; and from about 0.05 wt. % to about 20 wt. % of one or more quaternary ammonium agent. During battery charging, the lower molecular weight halide ions in the uncharged electrolyte (for example, bromide and chloride), are electrochemically converted to higher molecular weight polyhalides (for example, Br₃⁻, Br₅⁻ etc.) and higher molecular weight mixed polyhalides (for example, BrCl₂⁻, ClBr₂⁻ etc. or combination thereof). The quantity and type of polyhalides and mixed polyhalides formed during charging depends on a number of uncharged electrolyte variables, including, halide concentration, pH, chloride to bromide ratio, battery charge capacity, and battery voltage. Once the higher molecular weight polyhalides and mixed polyhalides are formed electrochemically, they are typically chemically complexed with a quaternary ammonium agent. The complex of the quaternary ammonium agent and the polyhalide or the mixed polyhalide can be stored until the battery is discharged.

In some embodiments, a mixed polyhalide is formed when the uncharged electrolyte (with different halides at the predetermined ratio) within an electrochemical cell has undergone charging until it has reached an open circuit potential of at least 1.82V and a volumetric charge capacity of at least 54 mAh/mL. In some embodiments, a mixed polyhalide is formed when the uncharged electrolyte (with different halides at the predetermined ratio) within an electrochemical cell has undergone charging until it has reached an open circuit potential of greater than 1.82V and a volumetric charge capacity of greater than 54 mAh/mL. A non-limiting example of an open circuit potential of greater than 1.82V is 1.83 V-2.10 V. A non-limiting example of a volumetric charge capacity of greater than 54 mAh/mL is 55 mAh/ml-104 mAh/ml.

In some embodiments, the mixed polyhalides may be produced by subjecting the cell to further charge once the cell has already received a significant charge. Such mixed polyhalides have a general formula [X₍₂ₙ₊₁₎Y₍₂ₘ₎]⁻, where X and Y are different from each other and are independently either Cl or Br, n is an integer between 0 and 5, and m is an integer between 1 and 5. Non-limiting examples of the mixed polyhalides produced during the charging process include, for example, BrCl₂⁻ (MW of 150.8 g/mol), ClBr₂⁻ (MW of 195.3 g/mol), or combination thereof.

In some embodiments, a total molar ratio of chloride ions to bromide ions in the uncharged electrolyte is from about 1:1 to about 13:1. In some embodiments, a total molar ratio of chloride ions to bromide ions in the uncharged electrolyte is from about 1:1 to about 2:1. In yet another embodiment, a total molar ratio of chloride ions to bromide ions in the uncharged electrolyte is from about 1.25:1 to about 1.5:1.

In some embodiments, the electrolyte after charge, irrespective of charge capacity, does not have a density gradient along a length of an electrode during the charging process. In some embodiments, the electrolyte after charge forms a lower density gradient during the charging process compared to an electrolyte that comprises a total chloride to bromide molar ratio of less than about 1:1.

In some embodiments, a density of the initial electrolyte is from about 1.2 to about 2.10 g/cm³. In some embodiments, a density of the electrolyte at the end of charge is from about 1.4 to about 2.20 g/cm³, when the electrochemical cell containing the initial electrolyte has undergone at least a significant charge.

In some embodiments, a ratio of a density of the initial electrolyte to a density of the electrolyte after charge is from about 1.3 to about 1. In one aspect, such ratios are obtained when the electrochemical cell containing the initial electrolyte has undergone at least a significant charge. In another embodiment, a ratio of a density of the initial electrolyte to a density of the electrolyte after charge is from about 1.15 to about 1. In one aspect, such ratios are obtained when the electrochemical cell containing the initial electrolyte has undergone at least a significant charge

In some embodiments, the initial electrolyte of the present disclosure produces a higher coulombic efficiency in the static secondary zinc halide electrochemical battery compared to a static secondary zinc halide electrochemical battery with an initial electrolyte before charge that comprises a total chloride to bromide molar ratio of less than about 1:1.

In some embodiments, the initial electrolyte further comprises other components suitable within the scope of the disclosure. For example, the additional components in the initial electrolytes described in PCT Publication No. WO 2016/057477, filed Oct. 6, 2015, in PCT Publication No. WO 2017/172878, filed Mar. 29, 2017, in U.S. Pat. No. 10,276,872, filed Mar. 29, 2016, and in U.S. Patent Application Publication No. 2011/0253553 A1, filed Mar. 21, 2011, all of which are incorporated herein by reference, may be used within the scope of the disclosure.

In some embodiments, the initial electrolyte further comprises from about 0.5 wt. % to about 15 wt. % of KBr and from about 0.5 wt. % to about 15 wt. % of KCl.

In some embodiments, the initial electrolyte further comprises from about 0.5 wt. % to about 15 wt. % of KCl. In some embodiments, the initial electrolyte does not comprise KBr. In some embodiments, the initial electrolyte comprises about 0 wt. % KBr.

The initial electrolyte comprises one or more source(s) for chloride ions. Non-limiting examples of the one or more source for chloride ions include, for example, ZnCl₂, KCl, NH₄Cl, LiCl, CuCl₂, CaCl₂, FeCl₃, SbCl₃, CrCl₃, NaCl, BiCl₃, quaternary ammonium salts with chloride anions.

The initial electrolyte comprises one or more source(s) for bromide ions. Non-limiting examples of the one or more source for bromide ions include, for example, ZnBr₂, KBr, NH₄Br, LiBr, CuBr₂, CaBr₂, NaBr, AgBr, AlBr₃, quaternary ammonium salts with bromide anions.

In some embodiments, the initial electrolyte comprises ZnBr₂, ZnCl₂, KCl, and KBr. In some embodiments, a total molar ratio of chloride ions to bromide ions in the initial electrolyte is from about 1:1 to about 13:1. In another embodiment, a total molar ratio of chloride ions to a total molar ratio of bromide ions in the initial electrolyte is from about 1:1 to about 2:1. In yet another embodiment, a total molar ratio of chloride ions to a total molar ratio of bromide ions in the initial electrolyte is from about 1.25:1 to about 1.5:1.

In some embodiments, the initial electrolyte comprises from about 0.05 wt. % to about 20 wt. % of one or more quaternary ammonium agents. Each quaternary ammonium agent is independently selected from a quaternary ammonium agent having a formula N+(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide.

In some embodiments, the one or more quaternary ammonium agents comprises a first quaternary ammonium agent. In some embodiments, the first quaternary ammonium agent is selected from a tetra-C₁₋₆ alkyl ammonium chloride or a tetra-C₁₋₆ alkyl ammonium bromide. In some embodiments, the first quaternary ammonium agent is tetramethylammonium chloride, tetraethylammonium chloride, tetrapropylammonium chloride, tetrabutylammonium chloride, tetramethylammonium bromide, tetraethylammonium bromide, tetrapropylammonium bromide, or tetrabutylammonium bromide.

In some embodiments, the one or more quaternary ammonium agents further comprises a second quaternary ammonium agent. In some embodiments, the second quaternary ammonium agent has a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide.

In some embodiments, the second quaternary ammonium agent is a chloride or bromide of trimethylethylammonium, trimethyl prop ylammonium, trimethylbutylammonium, triethylmethylammonium, triethylpropylammonium, triethylbutylammonium, tripropylmethylammonium, tripropylethylammonium, or tripropylbutylammonium.

In some embodiments, the initial electrolyte further comprises from about 0.1 wt. % to about 3 wt. % of a glycol, wherein the glycol is ethylene glycol, propylene glycol, 1,3-butylene glycol, 1,4-butylene glycol, neopentyl glycol, hexylene glycol, or any combination thereof. In one embodiment, the glycol is neopentyl glycol.

In some embodiments, the initial electrolyte further comprises from about 0.1 wt. % to about 3 wt. % of a glyme, wherein the glyme is monoglyme, diglyme, triglyme, tetraglyme, pentaglyme, hexaglyme, or any combination thereof. In one embodiment, the glyme is tetraglyme. In some embodiments, the glyme is dipropylene glycol dimethyl ether (DMM).

In some embodiments, the initial electrolyte further comprises less than 0.1 wt. % of one or more additives selected from Sn, In, Ga, Al, Tl, Bi, Pb, Sb, Ag, Mn, Fe, Cr, Sc, Cu, Al, Ru, Sr, or any combination thereof. In some embodiments, the initial electrolyte further comprises up to 1 wt. % of one or more additives selected from Sn, In, Ga, Al, Tl, Bi, Pb, Sb, Ag, Mn, Fe, Cr, Sc, Cu, Al, Ru, Sr, or any combination thereof.

In some embodiments, the initial electrolyte comprises: from about 5 wt. % to about 40 wt. % of ZnBr₂; from about 5 wt. % to about 60 wt. % of ZnCl₂; from about 10 wt. % to about 60 wt. % of H₂O; from about 1 wt. % to about 10 wt. % of KBr; from about 1 wt. % to about 20 wt. % of KCl; and from about 0.05 wt. % to about 20 wt. % of the one or more quaternary ammonium agents.

In some embodiments, the initial electrolyte comprises: from about 5 wt. % to about 40 wt. % of ZnBr₂; from about 5 wt. % to about 60 wt. % of ZnCl₂; from about 10 wt. % to about 60 wt. % of H₂O; from about 1 wt. % to about 20 wt. % of KCl; and from about 0.05 wt. % to about 20 wt. % of the one or more quaternary ammonium agents.

In some embodiments, the initial electrolyte further comprises from about 0.1 wt. % to about 3 wt. % of DME-PEG. In some embodiments, the initial electrolyte comprises DME-PEG with a number average molecular weight of about 1000 amu, DME-PEG with a number average molecular weight of about 2000 amu, or a combination thereof.

In some embodiments, the initial electrolyte further comprises from about 0.1 wt. % to about 3 wt. % of PEG. In some embodiments, the initial electrolyte comprises PEG with a number average molecular weight of about 1000 amu, PEG with a number average molecular weight of about 3500 amu, or a combination thereof.

In some embodiments, the initial electrolyte does not comprise DME-PEG.

In some embodiments, the initial electrolyte does not comprise PEG.

Non-limiting examples of the initial electrolyte that will yield the mixed polyhalide of the present disclosure when the electrochemical cell containing the initial electrolyte has undergone at least a significant charge are provided in TABLE 1-Part 1 and TABLE 1-Part 2 below.

TABLE 1
Part 1

| Ingredient (wt. %) | 1 | 2 | 3 | 4 | 5 | 6 | 7 | 8 | 9 |
|---|---|---|---|---|---|---|---|---|---|
| Zinc Bromide | 19.5 | 11.5 | 4 | 7.6 | 14 | 16.7 | 22 | 17.5 | 14.5 |
| Zinc Chloride | 24 | 28 | 33 | 30 | 26 | 24 | 19.5 | 19 | 17 |
| Potassium Bromide | 7.5 | 7.5 | 7.5 | 7.5 | 7.5 | 7.5 | 7.5 | 7.5 | 7.5 |
| Potassium Chloride | 9.4 | 9.4 | 9.4 | 9.4 | 9.4 | 9.4 | 9.4 | 9.4 | 9.4 |
| Water | 30 | 34 | 36.5 | 35.88 | 33.48 | 32.78 | 31.98 | 37.78 | 41.98 |
| Triethylmethylammonium Cl | 7 | 7 | 7 | 7 | 7 | 7 | 7 | 7 | 7 |
| DME-PEG 2K | 0.62 | 0.62 | 0.62 | 0.62 | 0.62 | 0.62 | 0.62 | 0.62 | 0.62 |
| DME-PEG 1K | 0.22 | 0.22 | 0.22 | 0.22 | 0.22 | 0.22 | 0.22 | 0.22 | 0.22 |
| Neopentyl Glycol | 0.87 | 0.87 | 0.87 | 0.87 | 0.87 | 0.87 | 0.87 | 0.87 | 0.87 |
| Tetraglyme | 0.91 | 0.91 | 0.91 | 0.91 | 0.91 | 0.91 | 0.91 | 0.91 | 0.91 |

TABLE 1
Part 2

| Ingredient (wt. %) | 10 | 11 | 12 |
|---|---|---|---|
| Zinc Bromide | 23.80 | 23.80 | 23.80 |
| Zinc Chloride | 19.70 | 19.70 | 19.70 |
| Potassium Bromide | — | — | — |
| Potassium Chloride | 14.10 | 14.10 | 14.10 |
| Water | 32.78 | 32.78 | 32.78 |
| Triethylmethylammonium Cl | 7.00 | 7.00 | 7.00 |
| DME-PEG 2K | 0.62 | — | 0.62 |
| DME-PEG 1K | 0.22 | — | 0.22 |
| PEG 3350 | — | 0.62 | — |
| PEG 1000 | — | 0.22 | — |
| Neopentyl Glycol | 0.87 | 0.87 | 0.87 |
| Tetraglyme | 0.91 | 0.91 | — |
| Dipropylene glycol | — | — | 0.91 |
| dimethyl ether | | | |

The initial electrolyte with a mixed polyhalide according to embodiments in the present disclosure has also been found to advantageously improve the coulombic efficiency of the static secondary zinc halide electrochemical battery. In some embodiments, the coulombic efficiency of the static secondary zinc halide electrochemical battery with a mixed polyhalide initial electrolyte according to embodiments in the present disclosure is increased by about 3% to about 8% compared to an equivalent static secondary zinc bromide battery with an initial zinc bromide electrolyte which forms polybromide on charge and does not form the mixed polyhalide in the electrolyte as in the present disclosure. This is demonstrated in the EXAMPLES below.

The initial electrolyte with a mixed polyhalide according to embodiments in the present disclosure may advantageously improve the current density distribution across the height of the electrodes of the static secondary zinc halide electrochemical battery.

The inventors of the present disclosure have also unexpectedly found that it is possible to achieve these results with initial electrolytes created at pH of about 3. Prior to this invention, it was believed that BrCl₂ reaction only happens in very low pH electrolytes with a pH of about 1 or below, or very concentrated electrolytes with little free water.

Chloride and bromide concentration in the initial electrolyte may be determined as follows: a cell may be charged using the protocol described in EXAMPLE 3 below. The cell may then be removed from electrical connections, and the cell may then be opened to remove aliquots of electrolyte from the cell. An aliquot (e.g., 10 mL) may be obtained from the top of the cell and an aliquot (e.g., 10 mL) may be obtained from the bottom of the cell. Bromide and chloride concentrations may be determined analytically for each aliquot to demonstrate chemically the distribution of bromide and chloride at the top and the bottom for various electrolytes.

Open circuit voltage of the cell may be determined as follows: A cell may be charged using the protocol described in EXAMPLE 3 below. The open circuit voltage of the cell may be measured after charging. This open circuit voltage may vary depending on the final composition of the mixed polyhalides after charging.

UV vis spectra of electrolyte after charging may be determined as follows: A cell may be charged using the protocol described in EXAMPLE 3 below. A cell may be removed from electrical connections, and then the cell may be opened to remove aliquots of electrolyte from the cell. An aliquot (e.g., 10 mL) may be obtained from the top of the cell and an aliquot (e.g., 10 mL) may be obtained from the bottom of the cell and UV Visible spectroscopy may be performed on each aliquot. The type of mixed polyhalide formed may have different UV visible spectroscopy, as the color of the mixed polyhalide changes depending on bromide and chloride in the mixed polyhalide, as shown, for example, in FIG. 6.

Electrolyte density gradient may be determined as follows: A cell may be charged using the protocol described in EXAMPLE 3 below. The cell may then be removed from electrical connections, and the cell may then be opened to remove aliquots of electrolyte from the cell. An aliquot (e.g., 10 mL) may be obtained from the top of the cell and an aliquot (e.g., 10 mL) may be obtained from the bottom of the cell and electrolyte density measurements may be performed on each aliquot.

B. Electrochemical Battery

Another aspect the present disclosure provides a secondary zinc halide battery comprising the initial electrolyte described above. The secondary zinc halide battery is a static (non-flowing) secondary zinc halide battery. Static battery constructions are well known to one skilled in the art. In the aspects below, the battery is described as a static bipolar electrochemical battery. One skilled in the art is aware of alternative battery constructions, such as unipolar (or monopolar) batteries. As such, alternative static battery constructions are not discussed in detail herein.

B. Static Bipolar Electrochemical Battery

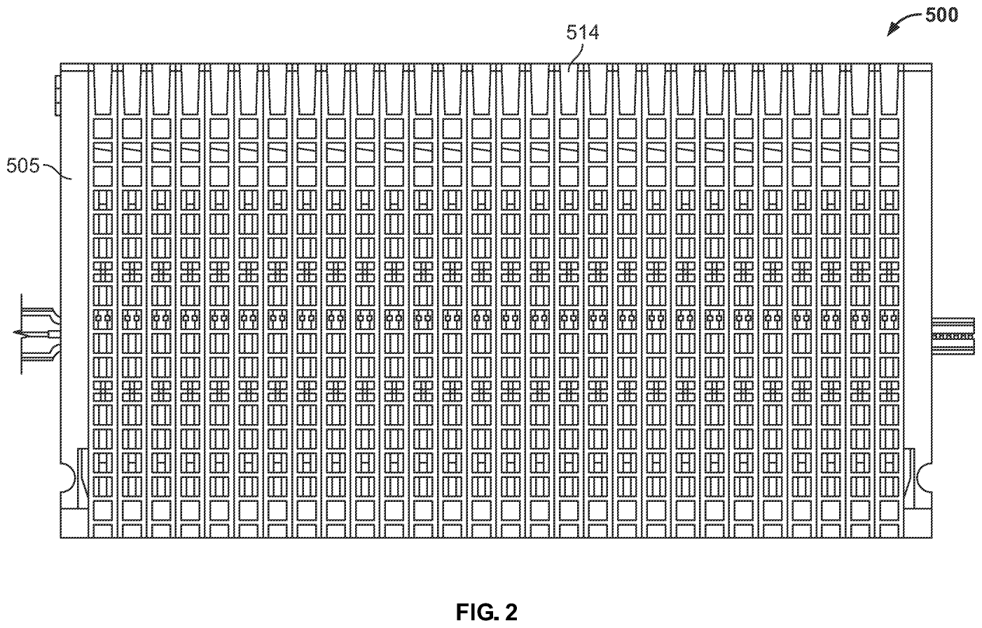

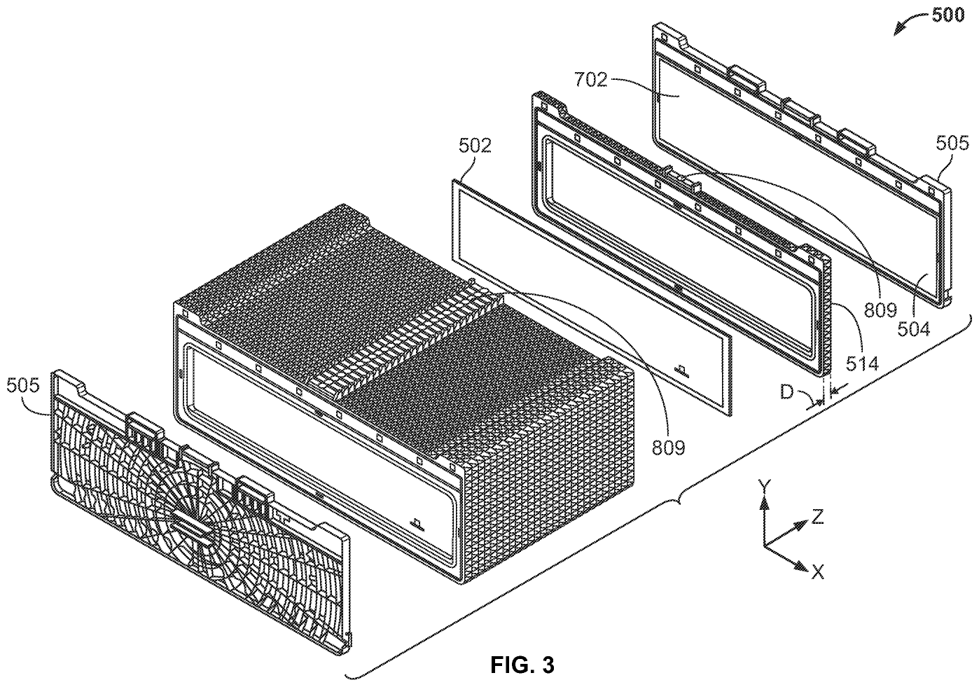

Referring to FIGS. 2 and 3, an embodiment of a static (non-flowing) bipolar zinc halide secondary electrochemical battery 500 of the present disclosure comprises at least one bipolar electrochemical cell and two terminal electrochemical cells. In some embodiments, the bipolar electrochemical battery comprises about 10 to 50 bipolar electrochemical cells in series and two terminal electrochemical cells. For example, in one embodiment, the bipolar electrochemical battery comprises 26 bipolar electrochemical cells in series and two terminal electrochemical cells. In another embodiment, the bipolar electrochemical battery comprises 38 bipolar electrochemical cells in series and two terminal electrochemical cells.

B.i. Bipolar Electrochemical Cell

The at least one bipolar electrochemical cell comprises a bipolar electrode 502, a battery frame member 514, and a zinc halide electrolyte. The terminal electrochemical cell comprises a bipolar electrode 502, a battery frame member 514, a terminal assembly 504, a terminal endplate 505, and a zinc halide electrolyte.

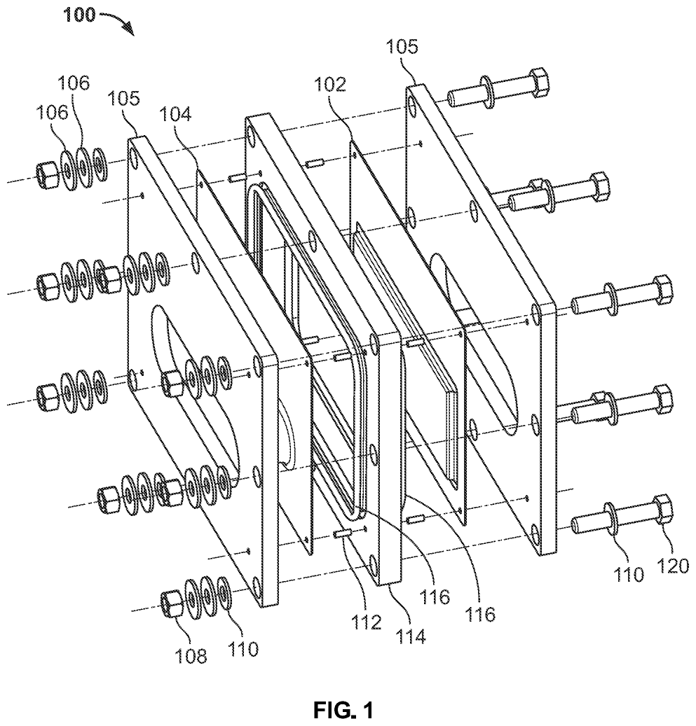

FIG. 1 shows an exploded view of an electrochemical cell 100 of the present disclosure, which comprises a bipolar electrode 102, a battery frame member 114, a terminal assembly 104, and the initial zinc halide electrolyte described above.

1. Bipolar Electrodes

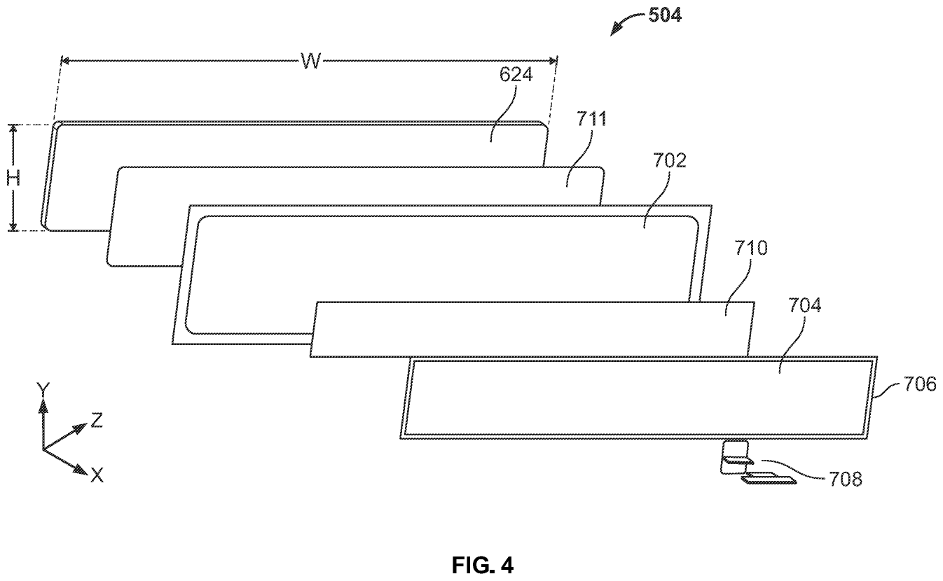

Referring to FIGS. 3 and 4, bipolar electrodes 502 of present disclosure comprise a bipolar electrode plate 702 having an anode surface on one side of the bipolar electrode plate and a cathode surface on another side of the bipolar electrode plate that is opposite the anode surface. On the cathode surface of the bipolar electrode plate 702, a carbon material 624 is affixed to the surface of the bipolar electrode plate 702 using an adhesive layer 711 so that the carbon material 624 electrically communicates with at least the surface of the bipolar electrode plate 702. The structure of the bipolar electrodes 502 is described by referring to the exploded view of the terminal assembly 504 in FIG. 4 as the structure of the bipolar electrodes 502 is identical to the structure of the bipolar electrode of the terminal assembly 504.

Bipolar electrodes 502 of the present disclosure are configured to plate zinc metal on an anodic electrode surface and generate halide or mixed halide species during charging of the electrochemical cell that are reversibly sequestered in the carbon material. Conversely, these electrodes are configured to oxidize plated zinc metal to generate Zn²⁺ cations and reduce the halide or mixed halide species to their corresponding anions during discharging of the electrochemical cell.

a. Bipolar Electrode Plates

The bipolar electrode plate 702 comprises a conductive coating or a film that is relatively inert to the zinc halide electrolyte used in the electrochemical battery. In some embodiments, the coating or the film covers a portion of the surface of the bipolar electrode plate 702. In some embodiments, the bipolar electrode plate 702 comprises titanium, titanium oxide, TiC, TiN, or graphite. Optionally, the bipolar electrode plate 702 is a plastic material that is rendered conductive by incorporating a conductive filler into the plastic. In some embodiments, the bipolar electrode plate 702 comprises a titanium material (e.g., titanium or titanium oxide). In other embodiments, the bipolar electrode plate 702 comprises a titanium material that is coated with a titanium carbide material. In these embodiments, at least a portion of the surface of the bipolar electrode plate 702 is coated with the titanium carbide material. In some embodiments, the bipolar electrode plate 702 comprises an electrically conductive carbon material (e.g., a graphite plate). In some instances, the bipolar electrode plate 702 comprises a graphite plate that is coated with a titanium carbide material. In these embodiments, at least a portion of the surface of the bipolar electrode plate 702 is coated with the titanium carbide material. In some embodiments, the bipolar electrode plate 702 comprises an electrically conductive plastic. Any suitable electrically conductive plastic may be used within the scope of the invention. Conductive plastics are well known to one skilled in the art and not described in detail herein. Such electrically conductive plastic material may comprise a base resin polymer with carbon black, graphite, fumed silica, or combinations thereof. For example, electrically conductive plastics described in U.S. Pat. No. 4,169,816, filed Mar. 6, 1978, which is incorporated herein by reference, may be used within the scope of the disclosure.

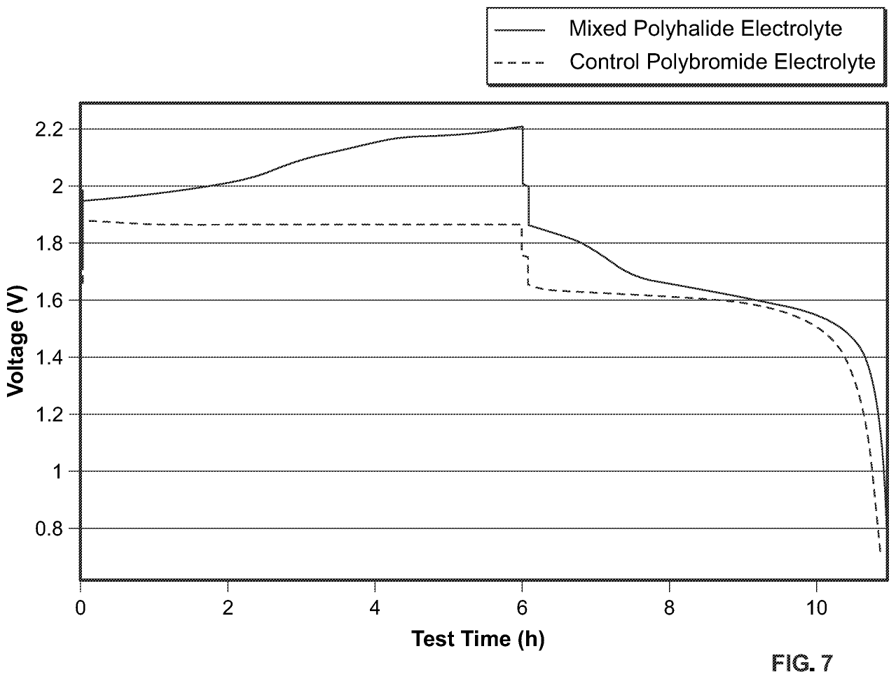

In some embodiments, the bipolar electrode plates may be substantially rectangular, with one dimension being visibly greater than the other so as to convey a rectangular appearance. In the X-Y-Z coordinate space illustrated in FIG. 3, the width dimension of the terminal assembly 504 is in the X direction and it is the greater dimension relative to Y. The height dimension of the terminal assembly 504 is in the Y direction and it is a shorter dimension compared with the X dimension, giving the illustrated terminal assembly 504 and the exploded battery a rectangular appearance. The Z direction is representative of the depth (i.e., thickness) of the illustrated battery components. As seen in FIGS. 3 and 4, the orientation of the bipolar electrode plates and the orientation of the carbon material are complementary to the orientation of the terminal assembly 504 such that the width and the height of the bipolar electrode plates and the width and height of the carbon material share about the same orientation as the width and the height, respectively, of the terminal assembly 504 shown in FIG. 7.

The bipolar electrode plates may be formed by stamping or other suitable processes. A portion of the surface of the bipolar electrode plate 702 may optionally undergo surface treatments (e.g., coating or the like) to enhance the electrochemical properties of the cell or battery. The inner surface of the bipolar electrode plate may include an electrochemically active region associated with or defined by the formation of a layer of zinc metal upon cell or battery charging. In some embodiments, the inner surface of the electrode plate may be sandblasted or otherwise treated within the electrochemically active region. In other embodiments, the outer surface may also be sandblasted within an electrochemically active region associated with a region enclosed by the cathode assembly.

For example, in some embodiments, at least a portion of the inner surface, at least a portion of the outer surface, or at least portions of both surfaces are treated (e.g., sandblasted) to give a rough surface. In some instances, at least a portion of the inner surface of the bipolar electrode plate is treated (e.g., sandblasted) to give a rough surface. In some instances, the region of the inner surface that is treated to give a rough surface is substantially defined by the periphery of the cathode assembly affixed to the outer surface of the electrode plate.

b. Cathode Assemblies

The electrochemical cell of the present disclosure comprises a cathode assembly that is situated on the cathode surface of the bipolar electrode plate 702. In some embodiments, the cathode assembly comprises at least one carbon material 624 and an adhesive layer 711 electrically connecting the carbon material 624 to a bipolar electrode plate 702. The carbon material is situated on the coating material that is on the surface (e.g., the cathodic surface) of the bipolar electrode plate 702. In other embodiments, the cathode assembly comprises a cathode cage, which electrically connects the carbon material 624 to the cathode surface of the bipolar electrode plate 702. A cathode cage is described in U.S. Provisional Application No. 63/168,699, filed Mar. 31, 2021, which is incorporated herein by reference, may be used within the scope of the disclosure.

i. Carbon Material

The carbon material 624 is in electrical communication with the surface of the bipolar electrode plate 702 and is adhered to the bipolar electrode plate 702 using an adhesive layer 711. Carbon materials suitable for electrochemical cells of the present disclosure may comprise any carbon material that can reversibly absorb aqueous bromine species (e.g., aqueous bromine or aqueous bromide) and is substantially chemically inert in the presence of the electrolyte. In some embodiments, the carbon material comprises carbon blacks or other furnace process carbons. Suitable carbon black materials include, but are not limited to, Cabot Vulcan® XC72R, Akzo-Nobel Ketjenblack EC600JD, and other matte black mixtures of conductive furnace process carbon blacks. In some embodiments, the carbon material may also include other components, including but not limited to a PTFE binder and de-ionized water. For example, the carbon material has a water content of less than 50 wt. % (e.g., from about 0.01 wt. % to about 30 wt. %) by weight of the carbon material. In some embodiments, the carbon material comprises PTFE (e.g., from about 0.5 wt. % to about 5 wt. % by weight of the carbon material).

In some embodiments, the carbon material may be in the form of one or more thin rectangular blocks. In some embodiments, the carbon material may comprise a single solid block. In other embodiments, the carbon material may comprise from one to five, one to three, or one to two solid blocks of carbon blacks.

In some embodiments, the carbon material may be comprised of a woven carbon fiber or a non-woven carbon felt material.

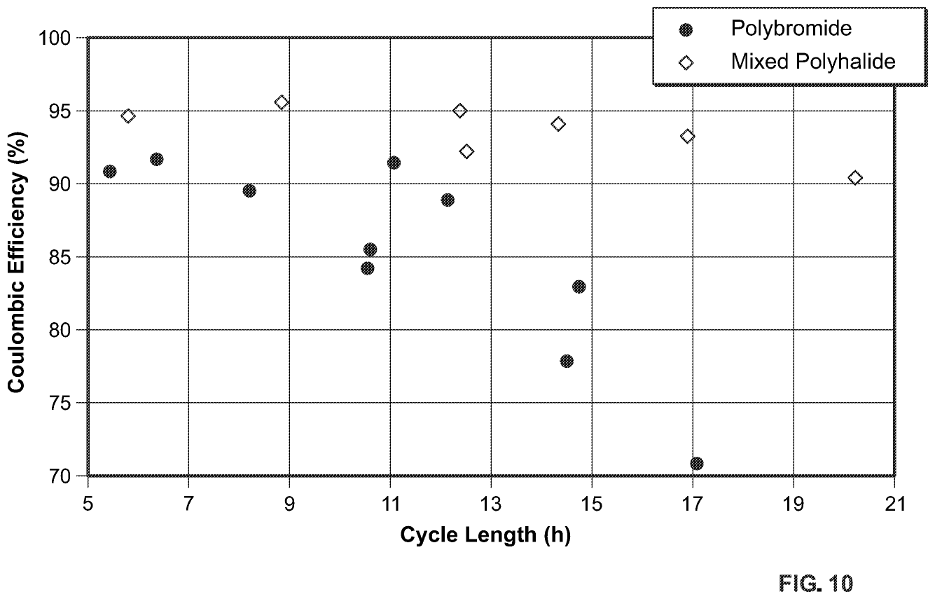

In some embodiments, the carbon material may be substantially rectangular, with one dimension being visibly greater than the other so as to convey a rectangular appearance. In the X-Y-Z coordinate space illustrated in FIGS. 3 and 4, the width dimension of the carbon material 624 is in the X direction (illustrated in FIG. 4 as “W”) and it is the greater dimension relative to Y, which gives the article a rectangular appearance. The height dimension of the carbon material 624 is in the Y direction (illustrated in FIGS. 4 and 10 as “H”) and it is the shorter dimension relative to the width dimension. The orientation of the bipolar electrochemical battery 500 and the orientation of the carbon material 624 are complementary such that the width and the height of bipolar electrochemical battery 500 are share about the same orientation as the width and the height, respectively, of the carbon material 624. A battery with such an embodiment of the carbon material is described in U.S. application Ser. No. 17/410,552, filed Aug. 24, 2021, which is incorporated herein by reference, may be used within the scope of the disclosure.

2. Terminal Assembly

Referring to FIG. 4, a terminal assembly 504 of the present disclosure comprises a terminal connector 708; a conductive flat-plate 704 with an electrically conducting perimeter 706; an electrically insulating tape member 710; and a terminal bipolar electrode plate 702. The conductive flat-plate 704, the terminal bipolar electrode plate 702 and the electrically insulating tape member 710 each have inner and outer surfaces at least substantially parallel with each other, wherein the outer surface of the conductive flat-plate 704 is joined to the terminal connector 708, the inner surface of the conductive flat-plate 704 is joined to the outer surface of the terminal bipolar electrode plate 702, with the electrically insulating tape member 710 disposed in between the inner surface of the conductive flat-plate 704 and the outer surface of the bipolar electrode plate 702 such that the electrically insulating tape member 710 does not cover the entire inner surface area of the conductive flat-plate 704, and wherein the electrically conducting perimeter 706 enables bi-directional uniform current flow through the conductive flat-plate 704 between the terminal connector 708 and the terminal bipolar electrode plate 702.

Since the insulating tape member 710 does not cover entire surface of the conductive flat-plate 704, it permits the electrically conducting perimeter 706 to be in electrical communication with the terminal bipolar electrode plate 702. In some embodiments, the dimensions of the insulating tape member 710 is smaller than the dimensions of the conductive flat-plate 704. The terminal connector 708 of the bipolar electrochemical battery is connected for electrical communication with the conductive flat-plate 304. In some embodiments, the outer surface of the conductive flat-plate 704 is joined to the terminal connector 708. In some embodiments, the terminal connector 708 comprises any electrically conducting material. In one embodiment, the terminal connection comprises brass (e.g., the terminal connector is a tab assembly that electrically communicates or contacts the terminal perimeter).

The terminal bipolar electrode plate 702 of the terminal assembly 504 has inner and outer surfaces at least substantially parallel with the inner and outer surfaces of the conductive flat-plate 704 and electrically insulating tape member 710. The terminal bipolar electrode plate 702 may comprise, without limitation, a titanium material that is coated with a titanium carbide material, thru holes, rough inner surface, or the like. The electrically conducting perimeter 706 of the flat-plate 704 with electrically insulating tape member 710 joins to the terminal bipolar electrode plate 702 such that the electrically conducting perimeter 706 is approximately centered about the electrochemically active region of the terminal bipolar electrode plate 702. In some embodiments, the electrochemically active region corresponds to a region extending between the inner and outer surfaces of the terminal bipolar electrode plate 702 in chemical or electrical communication with the adjacent bipolar electrode plate during charge and discharge cycles of the electrochemical battery. In these embodiments, the electrochemically active region for the terminal bipolar electrode plate 702 associated with the cathode terminal of the battery corresponds to or is defined by an area enclosed by a cathode assembly disposed upon the inner surface of the terminal bipolar electrode plate 702 (e.g., the terminal cathode electrode plate). The electrochemically active region for the terminal bipolar electrode plate 702 associated with the anode terminal of the battery may correspond to an area on its inner surface that opposes a cathode assembly disposed on the front surface of an adjacent bipolar electrode plate and forms a layer of zinc metal upon charging of the battery (terminal anode assembly). In some embodiments, at least a portion of the surface (e.g., at least the chemically active region) of the terminal bipolar electrode plate 702 of the terminal anode assembly is a rough surface.

FIG. 4 provides an exploded view of a terminal assembly for use in the battery of FIG. 2 showing the cathode carbon material 624, the adhesive layer 711, the terminal bipolar electrode plate 702, the electrically insulating tape member 710, the conductive flat-plate 704, the electrically conducting perimeter 306, and the terminal connector 708.

In some embodiments, the electrically conducting perimeter 706 formed by welding is centered within the electrochemically active region of the terminal bipolar electrode plate 702. In some embodiments, the electrically conducting perimeter 706 is substantially rectangular, substantially circular or substantially elliptical. In some embodiments, the electrically conducting perimeter 706 is substantially rectangular.

In some embodiments, the conductive flat-plate 704 with electrically insulating tape member 710 is centered within the electrochemically active region of the terminal bipolar electrode plate 702.

In some embodiments, the surface of the electrically insulating tape member is joined to the surface of the conductive flat-plate by a weld or an adhesive. In some embodiments, the adhesive is electrically conductive.

The conductive flat-plate described herein is larger than prior art current aggregators, and hence, it provides more contact points and better current density distribution. This reduces manufacturing costs.

In some embodiments, the terminal assembly is a terminal cathode assembly, wherein the terminal cathode assembly comprises a terminal bipolar electrode plate 702 having an electrochemically active region, a conductive flat-plate 704 with electrically insulating tape member 710 disposed on the surface of the terminal bipolar electrode plate 702 and approximately centered in the electrochemically active region, and a cathode assembly such as any of the cathode assemblies described herein disposed on the inner surface of the terminal bipolar electrode plate 702.

In some embodiments, the terminal assembly is a terminal anode assembly, wherein the terminal anode assembly comprises a terminal bipolar electrode plate 702 having an electrochemically active region, a conductive flat-plate 704 with electrically insulating tape member 710 centered in the electrochemically active region, and wherein the terminal anode assembly lacks a cathode assembly.

In some embodiments, the electrically conducting perimeter 706 of the conductive flat-plate 704 with electrically insulating tape member 710 is joined to the surface of the terminal bipolar electrode plate 702 by a weld or an adhesive. In some instances, the adhesive is electrically conductive. Non-limiting examples of suitable electrically conductive adhesives include graphite filled adhesives (e.g., graphite filled epoxy, graphite filled silicone, graphite filled elastomer, or any combination thereof), nickel filled adhesives (e.g., nickel filled epoxy), silver filled adhesives (e.g., silver filled epoxy), copper filled adhesives (e.g., copper filled epoxy), any combination thereof, or the like.

In some embodiments, the conductive flat-plate 704 with electrically insulating tape member 710 is composed of at least one of a copper alloy, a copper/titanium clad, aluminum, titanium, and electrically conductive ceramics.

In some embodiments, at least one of the conductive flat-plate 704 with electrically insulating tape member 710 or the terminal bipolar electrode plate 702 comprises titanium. In some embodiments, at least one of the conductive flat-plate 704 with electrically insulating tape member 710 or the terminal bipolar electrode plate 702 comprises a titanium material coated with a titanium carbide material.

In some embodiments, the inner surfaces of at least one of the conductive flat-plate 704 with electrically insulating tape member 710 comprises copper.

In some embodiments, the outer surface of at least one of the conductive flat-plate 704 with electrically insulating tape member 710 comprises at least one of copper, titanium, and electrically conductive ceramics.

In some embodiments, the conductive flat-plate 704 with electrically insulating tape member 710 comprises a first metal and the terminal bipolar electrode plate 702 comprises a second metal.

In some embodiments, the electrically insulating tape member 710 may be comprised of any adhesive material that is electrically insulating in nature. Non-limiting examples of the electrically insulating tape member 710 include, for example, Kapton™, Mylar™, polyimide, polyethylene, nylon, Teflon, neoprene, or any other electrically insulating polymer.

3. Battery Frame Members

In some embodiments, the battery of the present disclosure comprises a battery frame member 514 that is interposed between two adjacent bipolar electrodes or interposed between a bipolar electrode 502 and a terminal assembly 504 (e.g., a terminal anode assembly or a terminal cathode assembly).

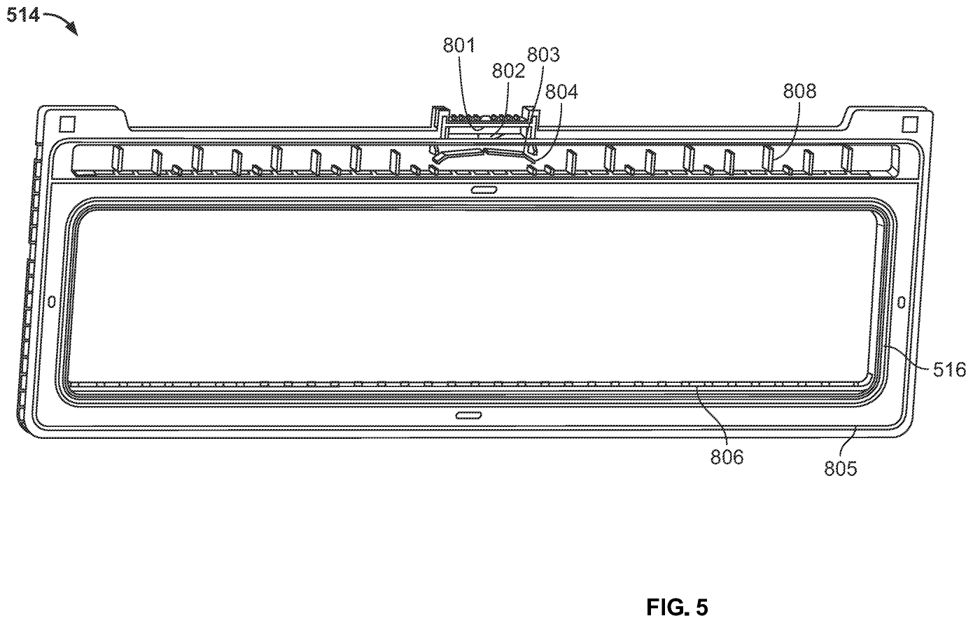

The width and the height of the battery frame member 514 are positioned complementary to the width “W” and the height “H”, respectively, of the carbon material 624. The width of the battery frame member 514 is the dimension along (parallel to) the bottom of the battery frame member 514, with the gas channel 801 located at the top of the battery frame member 514 (as illustrated in FIG. 5). In the X-Y-Z coordinate space illustrated in FIG. 3, the width dimension of the battery frame member 514 is in the X direction, while the height dimension of the battery frame member 514 is in the Y direction. The depth of the battery frame member 514 is in the Z direction and is the value of the dimension that is perpendicular to the height and the width of the battery frame member 514 (illustrated in FIG. 3 as “D”). In some embodiments, the frame member 514 is substantially rectangular, with one dimension being visibly greater than the other so as to convey a rectangular appearance.

In one embodiment, illustrated in FIG. 5, the battery frame member 514 has an outer periphery edge, and an inner periphery edge defining an open interior region. In some embodiments, the battery frame member 514 is configured such that open interior region is approximately centered about the center of an electrochemically active region of a terminal bipolar electrode plate 702 received by the battery frame member 514 and/or the center of a cathode assembly disposed on a terminal bipolar electrode plate 702. In some embodiments, the outer periphery of the battery frame member 514 defines the outer surface of a battery.

In some embodiments, the battery frame member 514 includes a first side that opposes and retains the first (terminal) bipolar electrode plate 702 and a second side disposed on an opposite side of the battery frame member 514 than the first side that opposes and retains a second bipolar electrode plate. The second electrode plate is adjacent and parallel to the first electrode plate in the battery. The first and second electrode plates and the terminal electrode plate(s) may be configured to have substantially the same size and shape. In some embodiments, the battery frame member 514 is in contact with an anode bipolar electrode plate on one side and a cathode bipolar electrode plate of the adjacent bipolar cell on the other side.

In some embodiments, the battery frame member 514 includes a sealing member 516 (FIG. 5) that extends around the inner periphery edge of the entire frame. In some embodiments, the battery frame member 514 comprises a first sealing member 516 disposed along the first inner periphery edge. In some embodiments, the first sealing member is an O-ring. In some embodiments, the first sealing member 516 is a gasket. In some embodiments, each inner periphery edge is configured to receive a sealing member 516 seated therein that forms a substantially leak-free seal when the seal is compressed between the corresponding bipolar electrode plate or terminal electrode plate and the battery frame member 514 when the electrochemical battery is assembled to provide a sealing interface between the bipolar electrode plate or endplate and the battery frame member 514. The sealing members cooperate to retain the electrolyte between the opposing bipolar electrode plates and a battery frame member 514, or between a bipolar electrode plate, a terminal electrode plate and a frame member 514. In some embodiments the sealing member 516 is overmolded onto the frame member 514. In some embodiments, the sealing member 516 is applied to the frame member 514 using a form in place liquid curing process. In some embodiments, the sealing member 516 extends above the depth of the frame member 514 and is compressed during assembly.

In some embodiments, the battery frame member 514 comprises a gutter in the bottom portion of the battery frame member 514 to prevent voltage anomalies during cycling. In some embodiments, the gutter comprises a gutter shelf 406 and a void space 407 underneath the gutter shelf 406. In some embodiments, the cathode carbon material 624 rests on the gutter shelf 406. It has been found that the presence of the gutter shelf and the void underneath the gutter shelf prevent voltage anomalies during cycling. In some embodiments, there is no void space 407 underneath the gutter shelf 406 and the gutter shelf 406 extends to the bottom of the battery frame member 514. In some embodiments, the gutter shelf 406, upon which the cathode carbon material 624 rests, may be between 0.5 and 5 cm tall, including void space 407 under gutter shelf 406, and may be between 3 and 10 mm wide along the entire bottom portion of the battery frame member 514 width.

In some embodiments, the battery frame member comprises a first frame member and a second frame member. In some embodiments, the first frame member and the second frame member are horizontally stacked and vertically oriented, wherein a first outer edge of the first frame member is substantially coplanar with a second outer edge of the second frame member.

In some embodiments of a battery, each battery frame member 514 is plastic welded to the adjacent frame member 514 using a weld bead 805 around the perimeter of the battery frame member 514.

In some embodiments, the battery frame member 514 comprises a gas channel 801 on the top of the battery frame member 514 directly above a ventilation hole 802. The ventilation hole 802 allows gas to escape into the gas channel 801. In some embodiments, the gas channel 801 associated with each battery frame member 514 is covered, so there is no need to place a cover over the gas channel 801 after the battery frame members are assembled together. As described herein, the gas channel 801 is the battery headspace for the gases from the electrochemical cell in the battery frame member 514. In some embodiments, the frame members 514 are filled with electrolyte through a fill hole (plug 809 is inserted therein as illustrated) in the gas channel and the gas channel 801 also communicates with the ventilation hole 802. Once the battery is filled with electrolyte, a plug 809 is inserted into the fill hole to seal the gas channel 801 from the environment. In those embodiments where the fill hole and the ventilation hole 802 are not the same, the ventilation hole remains open to the gas channel during battery operation. In other embodiments, the electrolyte is added to the battery through the ventilation hole.

In some embodiments, a liquid diversion system exists in the top of the battery frame member 514 directly below the ventilation hole 802 which allows gas to escape into a gas channel 801. While the gas channel 801 provides gas communication throughout the battery 500, the liquid diversion system prevents liquid from entering the gas channel 801 via a series of features. In some embodiments, the liquid diversion system comprises a primary diverter 803 with two partial blocking walls 804 and multiple secondary blocking walls 808 ensuring liquid always is directed back to the open interior region within the battery frame member 514. In some embodiments, the primary diverter 803 consists of a horizontal plastic protrusion with end pieces facing downward with an angle ranging from 30 to 60 degrees. In some embodiments, secondary blocking walls ensure minimum fluid will reach the primary diverter. In some embodiments, the secondary blocking walls 808 herein are designed to alternate top down and bottom up relative to the frame member 514 in order to break any internal electrolyte waves caused by severe sloshing or tilting. One of the advantages of the liquid diversion system is that it improves quality of the battery by keeping electrolyte contained within frame member during transportation.

Each battery frame member 514 may be formed from flame retardant polypropylene fibers, high density polyethylene, polyphenylene oxide, or polyphenylene ether. Each battery frame member 514 may receive two adjacent bipolar electrode plates or a bipolar electrode plate and a terminal electrode plate. Each battery frame member 514 may also house an aqueous electrolyte solution (e.g., zinc halide electrolyte or zinc-bromide electrolyte), which is received via the ventilation hole 802.

4. Compression Plates

In some embodiments, the electrochemical cell or battery comprises a pair of compression plates located at the ends of the electrochemical cell or battery. Suitable compression plates may be, for example, the compression plates described in PCT Publication No. WO 2019/108513, filed Nov. 27, 2018, which is incorporated herein by reference, may be used within the scope of the disclosure.

### III. EXAMPLES

### Example 1: Preparation of Mixed Polyhalide Electrolytes and Control Electrolytes

Aqueous mixed halide initial electrolyte solutions were prepared containing zinc bromide in the concentration range of 0.2 M-3.0 M, zinc chloride in the concentration range of 1.0 M-4.0 M, potassium halide salts in the concentration range 1.0-3.5 M and tetraalkylammonium salts in the concentration range 0.5-1.0 M. An initial aqueous electrolyte solution having a composition that is the same as the above, but with no zinc chloride was also prepared and served as the control electrolyte solution.

### Example 2: Comparison of Voltages Produced Using Mixed Polyhalide Electrolytes with Control Electrolytes

Test cells were assembled using titanium carbide coated titanium metal current collectors that were formed into plates. Anode and cathode plates were placed in a slotted high density polyethylene cell that held the plates in a parallel configuration 14 mm apart. Prior to cell assembly, carbon felts were attached to cathode titanium current collectors using 0.8 ml of an electrically conductive, acetone-based glue. Assembled cells were filled with 20 ml of the initial electrolyte described in EXAMPLE 1. The test cells were cycled using an Arbin Instruments battery cycler. The cells were charged at a constant current of 150 mA to a capacity of 0.9 Ah. The charge voltage limit was 2.3 V. The cells were discharged at a constant current of 140 mA until the voltage reached 1.1 V, after which the cells were further discharged at a constant current of 50 mA until the voltage reached 1.1 V. FIG. 7 shows representative voltage as a function of test time for a mixed polyhalide initial electrolyte according to embodiments in the present disclosure and a zinc bromide initial electrolyte which forms polybromide on charge and does not form the mixed polyhalide as in the present disclosure. The plot in FIG. 7 shows a cell with mixed polyhalide initial electrolyte with an open circuit voltage of 2V (compared to 1.75V for traditional zinc bromine battery), a start of discharge voltage of 1.86V (compared to 1.63V for traditional zinc bromine battery), and a discharge energy ˜10-20% higher (depends on chloride to bromide ratio) than traditional zinc bromine battery. The results of FIG. 7 are consistent with the increased voltage of Equation (2) above. Notably, the discharge time is also considerably longer for the mixed polyhalide electrolyte. This higher coulombic efficiency suggests the proposed electrolyte density gradient reduction mechanism is effective in the mixed polyhalide initial electrolyte.

The change to a monotonically increasing charge voltage seen in FIG. 7 provides additional advantages with respect to the design and operation of a battery energy storage system (BESS) compared to a battery energy storage system with the control polybromide chemistry. State of charge monitoring is a key operational requirement of a BESS, and traditionally uses voltage measurements to track state of charge during operation. For the voltage profile of the control polybromide chemistry, this can be done during discharge but not during charge as there is no significant relationship between state of charge and charge voltage due to the flatness of the voltage profile. This significantly complicates state of charge monitoring and overcharge protection when using such a battery. In contrast, the monotonically increasing voltage of the polyhalide chemistry means the simpler method of voltage tracking can be used during both charge and discharge.

Another advantage associated with monotonically increasing voltage of the polyhalide chemistry compared to batteries with the control polybromide chemistry is that it allows for the operation of the batteries in a parallel configuration. In such a configuration, the current flow across each battery will adjust to ensure each battery has the same overall voltage. To run such a configuration safely, it is important that the voltage state of charge relationship of the batteries provide a self-balancing effect, whereby a battery with a higher state of charge will have a higher voltage and thereby draw less current. In the absence of such an effect, operating batteries in parallel can lead to considerable state of charge imbalance as any current discrepancies will lead to long term accumulation of state of charge imbalance. The charge voltage profile of the control polybromide chemistry does not provide such a self-balancing effect, whereas the voltage profile of the polyhalide chemistry does. This leads to a significant improvement in operational flexibility and battery energy storage design possibilities.

### Example 3: Operating Conditions for Testing

Test cells were assembled using titanium carbide coated titanium metal current collectors that were formed into plates. Anode and cathode plates were placed in a parallel configuration separated by a 12 mm thick high-density polyethylene frame containing an embedded sealing ring that allowed the cell to be sealed by compressing the components between two opposing steel compression plates. Prior to cell assembly, carbon felts were attached to cathode titanium current collectors using 13 ml of an electrically conductive, acetone-based glue. Assembled cells were filled with 210 ml of the initial electrolyte described in EXAMPLE 1. The test cells were cycled using an Arbin Instruments battery cycler. Tests for discharge energy, coulombic efficiency, and self-discharge were performed under the following conditions:

Maximum charge voltage: 2.2 V-2.4 V

Minimum discharge voltage: 1.1 V

Charge Power range: 16 mW/cm²-41 mW/cm² (12 mW/mL-31 mW/mL)

Discharge Power range: 16 mW/cm²-41 mW/cm² (12 mW/mL-31 mW/mL)

Charge capacity range: 68 mAh/cm²-137 mAh/cm² (54 mAh/mL-104 mAh/mL)

Where the denominator for geometric area is normalized to the cathode electrode geometric surface area, and where the denominator is normalized to the available electrolyte volume in the cell in mL.

### Example 4: Effect of Cl/Br Ratio on Discharge Energy

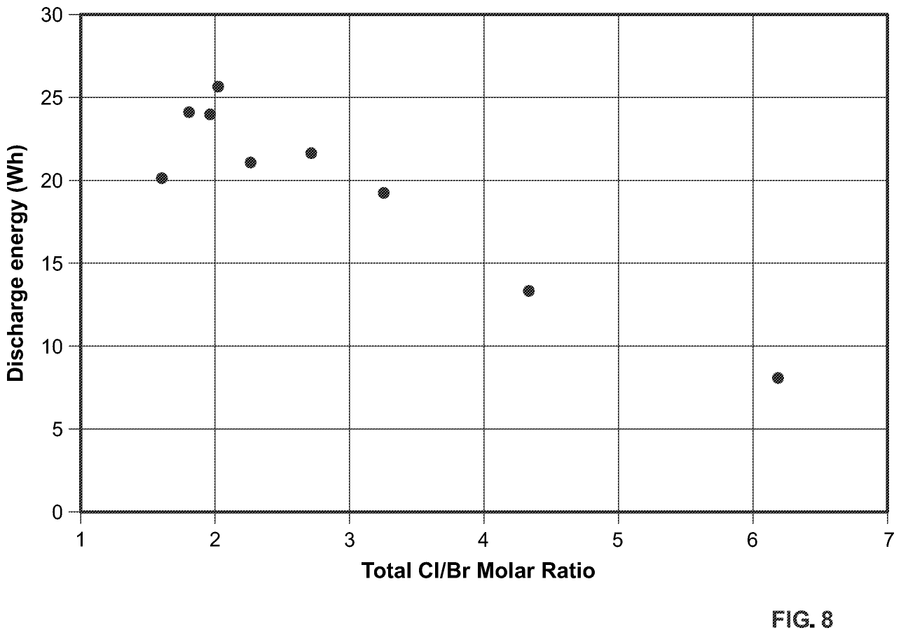

Cells were built and tested as described in EXAMPLE 3. FIG. 8 shows the effect of total Cl/Br molar ratio in a mixed polyhalide initial electrolyte according to embodiments in the present disclosure on discharge energy (Wh) when cells with a 165 cm 2 cathode geometric surface area are charged to a capacity of 97 mAh/cm². There is a maximum discharge energy when the chloride to bromide ratio is around 2:1. This suggests there is an optimal ratio at which mixed polyhalide species are dominant on charge, below this ratio it is likely that dense polybromide species dominate and above this ratio there is insufficient bromide available at the electrode to form mixed polyhalides. There may be competing effects of halide ratios and differing beneficial ratios may be obtainable.

### Example 5: Comparison of Coulombic Efficiency of Cells with Mixed Polyhalide Electrolyte with Polybromide Only Cells

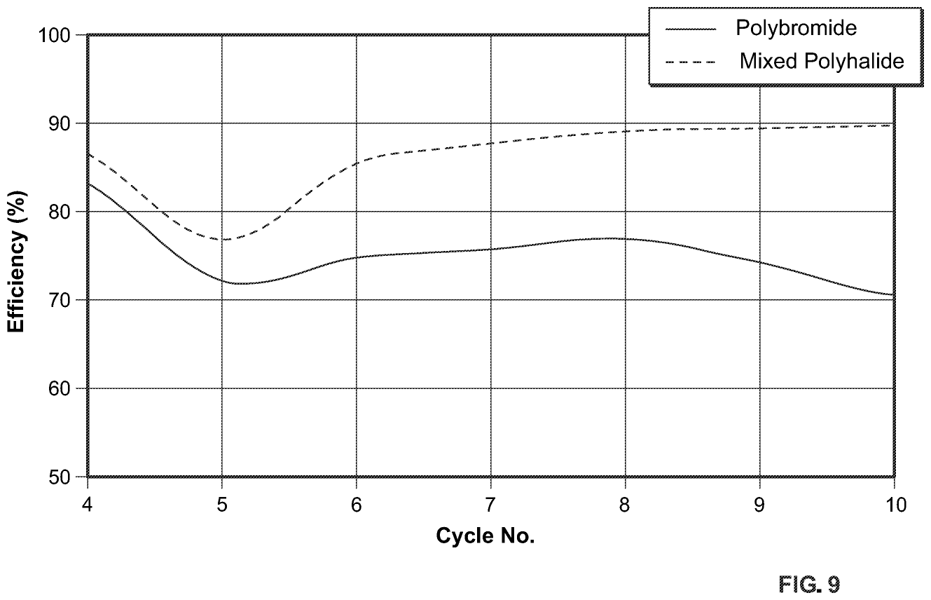

FIG. 9 shows representative average coulombic efficiency (%) over ten charge and discharge cycles for a mixed polyhalide initial electrolyte according to embodiments in the present disclosure and a zinc bromide initial electrolyte which forms polybromide on charge and does not form the mixed polyhalide as in the present disclosure. The mixed polyhalide-forming electrolyte consistently had higher coulombic efficiency than the polybromide only electrolyte.

### Example 6: Comparison of Coulombic Efficiency in Cells with Mixed Polyhalide Electrolytes Versus Polybromide Only Cells as a Function of Cycle Length

Cells were built and tested as described in EXAMPLE 3. In order to investigate coulombic efficiency as a function of cycle length, the cycle length was varied by changing the charge power. FIG. 10 shows representative average coulombic efficiency as a function of cycle length for a mixed polyhalide initial electrolyte according to embodiments in the present disclosure and a polybromide only initial electrolyte which forms polybromide on charge and does not form the mixed polyhalide as in the present disclosure. The coulombic efficiency declined with cycle length for the polybromide-forming initial electrolyte whereas it stayed fairly consistent for the mixed polyhalide-forming electrolyte. This suggests that the self-discharge rate is lower for the mixed polyhalide species compared to polybromide.

### Example 7: Comparison of Cell Discharge Voltage in Cells with Mixed Polyhalide Electrolytes Versus Polybromide Only Cells

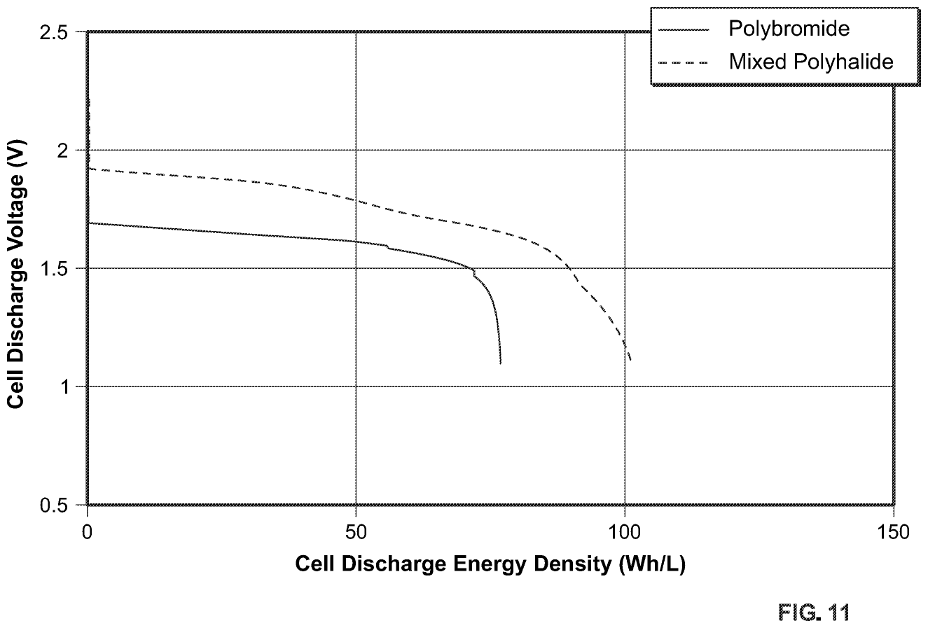

Cells were built and tested as described in EXAMPLE 3. FIG. 11 shows representative cell discharge voltage (V) as a function of cell discharge energy density (Wh/L) for a mixed polyhalide initial electrolyte according to embodiments in the present disclosure and a zinc bromide initial electrolyte that forms polybromide on charge and does not form the mixed polyhalide as in the present disclosure. Mixed polyhalide initial electrolyte exhibits higher discharge voltage and longer discharge time than zinc bromide only initial electrolyte.

### OTHER EMBODIMENTS

It should be apparent that the foregoing relates only to the preferred embodiments of the electrolyte and the battery disclosed herein, and that numerous changes and modifications may be made herein without departing from the spirit and scope of any invention as defined by the following claims and equivalents thereof.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A method for fabricating a static battery cell comprising the steps of:
providing an initial electrolyte comprising one or more source for chloride ions and one or more source for bromide ions, wherein the one or more source for chloride ions and the one or more source for bromide ions are provided in a predetermined ratio selected to yield a target amount of mixed polyhalide upon at least significant charge of the initial electrolyte; and
forming an electrochemical cell comprising an anode, a cathode and the initial electrolyte.

2. The method of claim 1, wherein the static battery cell is a static zinc halide electrochemical cell.

3. The method of claim 2, wherein the static zinc halide electrochemical cell is in a static zinc halide battery.

4. The method of claim 2, wherein the initial electrolyte comprises from about 5 wt. % to about 30 wt. % of ZnBr₂; from about 5 wt. % to about 60 wt. % of ZnCl₂; from about 10 wt. % to about 60 wt. % of H₂O; and from about 0.05 wt. % to about 20 wt. % of one or more quaternary ammonium agent.

5. The method of claim 4, wherein the mixed polyhalide produced upon at least significant charge of the initial electrolyte has a general formula [X₍₂ₙ₊₁₎Y₍₂ₘ₎]⁻, where X and Y are different from each other and are independently either Cl or Br, n is an integer between 0 and 5, and m is an integer between 1 and 5.

6. The method of claim 5, wherein the mixed polyhalide is BrCl₂⁻, ClBr₂⁻, or combination thereof.

7. The method of claim 4, wherein the one or more source for chloride ions is ZnCl₂, KCl, NH₄Cl, LiCl, CuCl₂, CaCl₂, FeCl₃, SbCl₃, CrCl₃, NaCl, BiCl₃, quaternary ammonium salts with chloride anions, or combination thereof.

8. The method of claim 4, wherein the one or more source for bromide ions is ZnBr₂, KBr, NH₄Br, LiBr, CuBr₂, CaBr₂, NaBr, AgBr, AlBr₃, quaternary ammonium salts with bromide anions, or combination thereof.

9. The method of claim 4, wherein the predetermined ratio of the one or more source for chloride ions and the one or more source for bromide ions is a molar ratio of total chloride ions to total bromide ions from about 1:1 to about 13:1.

10. The method of claim 9, wherein the predetermined ratio of the one or more source for chloride ions and the one or more source for bromide ions is a molar ratio of total chloride ions to total bromide ions from about 1:1 to about 2:1.

11. The method of claim 4, wherein the initial electrolyte further comprises from about 0.5 wt. % to about 15 wt. % of KBr and from about 0.5 wt. % to about 15 wt. % of KCl.

12. The method of claim 4, wherein the initial electrolyte further comprises from about 0.5 wt. % to about 15 wt. % of KCl.

13. The method of claim 12, wherein the initial electrolyte comprises about 0 wt. % of KBr.

14. The method of claim 4, wherein the one or more quaternary ammonium agent is independently selected from a quaternary ammonium agent having a formula N⁺(R¹)(R²)(R³)(R⁴)X⁻, wherein R¹ is hydrogen or an alkyl group, R², R³, and R⁴ are each independently an alkyl group that is same or different from R¹, and X⁻ is chloride or bromide.

15. The method of claim 4, wherein the one or more quaternary ammonium agent is independently selected from tetramethylammonium chloride, tetraethylammonium chloride, tetrapropylammonium chloride, tetrabutylammonium chloride, tetramethylammonium bromide, tetraethylammonium bromide, tetrapropylammonium bromide, or tetrabutylammonium bromide.

16. The method of claim 4, wherein the initial electrolyte further comprises from about 0.1 wt. % to about 3 wt. % of a glyme, wherein the glyme is monoglyme, diglyme, triglyme, tetraglyme, pentaglyme, hexaglyme, or any combination thereof.

17. The method of claim 4, wherein the initial electrolyte further comprises up to 1 wt. % of one or more additives selected from Sn, In, Ga, Al, Tl, Bi, Pb, Sb, Ag, Mn, Fe, Cr, Sc, Cu, Al, Ru, Sr, or any combination thereof.

18. The method of claim 4, wherein the initial electrolyte further comprises DME-PEG with a number average molecular weight of about 1000 amu, DME-PEG with a number average molecular weight of about 2000 amu, or a combination thereof.

19. The method of claim 4, wherein the initial electrolyte further comprises PEG with a number average molecular weight of about 1000 amu, PEG with a number average molecular weight of about 3500 amu, or a combination thereof.

20. The method of claim 1, wherein significant charge of the electrochemical cell is when the electrochemical cell has undergone charging until it has reached an open circuit potential of at least 1.82V and a volumetric charge capacity of at least 54 mAh/mL.
